(19) United States
(12) Patent Application Publication
(10) Pub. No.: US 2011/0205877 A1
(43) Pub. Date: Aug. 25, 2011

(54) OPTICAL DISC DRIVE AND METHOD FOR READING DATA FROM OPTICAL DISC

(76) Inventors: Katsuya Watanabe, Nara (JP); Takaharu Ai, Osaka (JP); Shinichi Yamamoto, Osaka (JP)

(21) Appl. No.: 13/023,573

(22) Filed: Feb. 9, 2011

(30) Foreign Application Priority Data
Feb. 19, 2010 (JP) 2010-034477

(51) Int. Cl. G11B 7/09; G11B 20/18

(52) U.S. Cl. 369/53.23; 369/53.22; G9B/7.076; G9B/20.046

(57) ABSTRACT

An optical disc drive according to the present invention is designed to read data from a multilayer optical disc 100, from/on which data can be read or written using a light beam. The drive includes a light source 222 for emitting a light beam, an objective lens 230 for converging the light beam, a photodetector 236 for detecting the light beam that has been reflected from the disc, and a control section 246 for setting a read power for a particular one of the multiple storage layers of the disc by reference to a read power table 501b. The table 501b stores multiple read powers for the respective storage layers in order to make S-curves of a focus error signal obtained from the respective layers have predetermined amplitudes. In this manner, the optical disc drive of the present invention can be loaded with a multilayer optical disc more smoothly by setting the best read powers for the respective storage layers of the disc.

### BACKGROUND OF THE INVENTION

1. Field of the Invention

The present invention relates to an optical disc drive for performing a read/write operation on either a double-layer optical disc or a multilayer optical disc with three or more storage layers. More particularly, the present invention relates to a technique for minimizing the damage that could be done by a read light beam and maintaining the quality of a read signal by carrying out a read operation with the best read power.

2. Description of the Related Art

A conventional high-storage-density optical disc such as a Blu-ray Disc (which will be referred to herein as either a “BD” or a “BD” disc) achieves as high a storage capacity as 25 GB or more with a single storage layer by using a laser beam with a wavelength of 450 nm and an objective lens with an NA (numerical aperture) of 0.8. Generally speaking, an optical disc includes a storage layer that stores information and a substrate that supports the storage layer. In a high-storage-density optical disc such as a BD, a light-transmissive layer (which is a light-transmitting protective coating called a “cover layer”) covers the signal reading side of that optical disc. As for such an optical disc, by irradiating its storage layer with a laser beam that has come through the cover layer side, an information signal can be read from, and written on, it. For example, an information signal can be read and written from/on such an optical disc by getting a laser beam with a wavelength of 400-410 nm condensed by an objective lens with a numerical aperture of 0.84 to 0.86 and irradiating the storage layer with such a laser beam through the cover layer.

An optical disc drive for performing a read/write operation on a multilayer optical disc with two, three or more storage layers needs to irradiate such a multilayer disc with a laser beam, of which the write power is higher than that of a laser beam to irradiate a normal single-layer optical disc. For example, a single-layer optical disc requires a write power of about 6 mW, while a double-layer optical disc requires a write power of about 15 mW. Also, a single-layer optical disc requires a read power of about 0.3 mW, while a double-layer optical disc requires a read power of about 0.7 mW. These powers are measured when the laser beam passes through the objective lens.

An optical disc drive that is compatible with both single-layer optical discs and multilayer ones is designed to recognize the type of a given optical disc and set the best write and read powers for that optical disc according to the type recognized. In this case, the write power is set to be an appropriate value by performing a test write operation on a predetermined area on that optical disc. On the other hand, the read power is adjusted to a preset value by APC (automatic power control).

As described above, a write operation can be performed on a single-layer optical disc with lower write power than on a multilayer optical disc. This means that as for a single-layer optical disc, the same read power could do damage on the data already stored there more easily than on a multilayer optical disc. For that reason, the read power is preferably set lower with respect to a single-layer optical disc than to a multilayer optical disc.

Meanwhile, the higher the power of a laser beam emitted, the more stabilized the noise of the laser beam (which is called relative intensity noise (RIN)) tends to be.

Japanese Patent Application Laid-Open Publication No. 2009-140580 (which will be referred to herein as “Patent Document No. 1” for convenience sake) discloses a technique for finding the best read power for a multilayer optical disc and a technique for preventing RIN noise generated in a single-layer optical disc from affecting the read performance seriously and for minimizing the damage that could be done by the read light beam. For these purposes, according to Patent Document No. 1, the read power is adjusted to the best one in the following manner. Specifically, the read power of a laser beam emitted from an optical pickup is initially set to be low enough to be affected easily by the laser noise but gradually increased after that to search for a read power that is higher than a preset threshold value but lower than a power value, at which an index value indicating the quality of a read signal (e.g., its jitter) becomes a minimum value. And when such a value is found, it will be set to be the best read power.

In a multilayer optical disc with three, four or more storage layers, to make the incoming light reach the deepest one of them (i.e., the one located closest to the substrate) with sufficient high intensity (which will be referred to herein as “incoming light intensity”), the shallowest one of those layers (i.e., the one located closest to the disc surface) needs to have its transmittance increased. For that purpose, the intensity of the light that has returned from the deepest layer (which will be referred to herein as a “reflected light intensity”) should also be sufficiently high. That is why it is more difficult to design the recording films of the respective layers so that those films have an appropriate combination of reflectances and transmittances. Consequently, in a multilayer optical disc, its layers tend to have lower reflectances and their variation tends to increase, too. For that reason, not just the read performance but also the focus and tracking controls would lose their stability easily.

Patent Document No. 1 certainly discloses a method for measuring the jitter value to find the best read power according to the type of the given optical disc but that method is applicable to only single-layer and double-layer optical discs. Also, to get that jitter measurement done accurately, focus and tracking controls need to be established with good stability, which is also easier said than done. That is why the best read power cannot be determined for each layer of a multilayer optical disc by such a conventional technique.

To overcome such problems, more strict standards could be set or tighter quality control could be done by testing. In that case, however, the yield of optical discs should decline and their manufacturing cost should rise, thus interfering with their popularization.

It is therefore an object of the present invention to provide an optical disc drive that can be loaded with any multilayer optical disc with good stability by setting the best read power for each of its multiple storage layers and also provide a method for reading data from such an optical disc.

### SUMMARY OF THE INVENTION

An optical disc drive according to the present invention is designed to read data from an optical disc loaded. The drive includes: a light source for emitting a light beam; an objective lens for converging the light beam; and a photodetector for detecting the light beam that has been reflected from the optical disc. If the multilayer optical disc has three or more storage layers, the optical disc drive sets a read power for at least one of the storage layers to be lower than read power(s) for the other storage layers.

In one preferred embodiment of the present invention, if the disc loaded is a multilayer optical disc with three or more storage layers, the ratio of read powers for the respective storage layers is fixed for the same type of the disc.

In an alternative preferred embodiment, if the disc loaded is a multilayer optical disc with three or more storage layers, the ratio of read powers for the respective storage layers is changed adaptively to the multilayer optical disc.

In this particular preferred embodiment, the ratio of the read powers for the respective storage layers is changed according to the ratio of the amplitudes of respective S-curves of a focus error signal that are obtained from the respective storage layers of the multilayer optical disc.

In a specific preferred embodiment, the ratio of the read powers for the respective storage layers is changed so that the respective S-curves of the focus error signal obtained from the respective storage layers of the multilayer optical disc have amplitudes that fall within a preset range.

In a more specific preferred embodiment, the read power for that target storage layer will be changed according to the ratio of the read powers for the respective storage layers when the light beam is focused on the target layer.

In an alternative preferred embodiment, when the focus is shifted from one of the storage layers to another by performing a focus jump operation, the read power for the latter storage layer will be changed according to the ratio of the read powers for the respective storage layers.

In still another preferred embodiment, when loaded with an optical disc, the drive performs an operation for detecting the number of storage layers that the optical disc has.

In yet another preferred embodiment, when loaded with an optical disc, the drive performs an operation for detecting the number of storage layers that the optical disc has and then determining, by the number of the storage layers detected, whether or not that disc is a multilayer optical disc with three or more storage layers.

In this particular preferred embodiment, in detecting the number of storage layers that the optical disc loaded has, the drive irradiates the optical disc with a light beam, of which the power is higher than the maximum one of read powers for the respective storage layers, and changes the focus position of the light beam simultaneously, thereby counting the number of times S-curves have been detected from a focus error signal.

In a specific preferred embodiment, the ratio of the read powers for the respective storage layers is determined by the amplitudes of respective S-curves of the focus error signal that are obtained from the respective storage layers of the multilayer optical disc when the number of storage layers that the optical disc loaded has is detected.

An optical disc reading method according to the present invention is a method for reading data from an optical disc loaded. The method includes the steps of: (A) determining whether or not the disc loaded is a multilayer optical disc with three or more storage layers; and if the disc loaded is a multilayer optical disc with three or more storage layers, (B) setting a read power for at least one of the storage layers to be lower than read power(s) for the other storage layers.

In one preferred embodiment of the present invention, the step (B) includes fixing the ratio of read powers for the three or more storage layers for the same the type of the multilayer optical disc.

In an alternative preferred embodiment, the step (B) includes changing the ratio of read powers for the three or more storage layers adaptively to the multilayer optical disc.

In this particular preferred embodiment, the step (B) includes changing the ratio of the read powers for the respective storage layers according to the ratio of the amplitudes of respective S-curves of a focus error signal that are obtained from the respective storage layers of the multilayer optical disc.

In a specific preferred embodiment, the step (B) includes changing the ratio of the read powers for the respective storage layers so that the respective S-curves of the focus error signal obtained from the respective storage layers of the multilayer optical disc have amplitudes that fall within a preset range.

In a more specific preferred embodiment, the method further includes the step of (C) focusing the light beam on a target one of the storage layers. And the step (C) includes changing the read power for that target storage layer according to the ratio of the read powers for the respective storage layers when the light beam is focused on the target layer.

In an alternative preferred embodiment, the method further includes the step of (D) shifting the focus of the light beam from one of the storage layers to another by performing a focus jump operation. And the step (D) includes changing the read power for the latter storage layer according to the ratio of the read powers for the respective storage layers when the focus is shifted to that layer.

In yet another preferred embodiment, the step (A) includes detecting the number of storage layers that the optical disc loaded has and then determining, by the number of the storage layers detected, whether or not the optical disc loaded is a multilayer optical disc with three or more storage layers.

In yet another preferred embodiment, the step (A) includes detecting the number of storage layers that the optical disc loaded has by counting the number of times S-curves have been detected from a focus error signal with the optical disc irradiated with a light beam, of which the power is higher than the maximum one of the read powers for the respective storage layers, and with the focus position of the light beam changed simultaneously.

In yet another preferred embodiment, the step (B) includes determining the ratio of the read powers for the respective storage layers by the amplitudes of respective S-curves of the focus error signal that are obtained from the respective storage layers of the multilayer optical disc when the number of storage layers that the optical disc loaded has is detected.

According to the present invention, by setting the best read powers for the respective storage layers of a given multilayer optical disc, the drive can be loaded with the optical disc smoothly.

In one preferred embodiment of the present invention, the best read powers are determined so that the amplitude of a focus error signal obtained from respective storage layers should be in a predetermined range. Consequently, the focus and tracking controls can get done with good stability and the read performance can be improved on a layer-by-layer basis.

Also, in another preferred embodiment of the present invention, when loaded with an optical disc, the drive instantly determines the best powers for the respective storage layers of that disc and draws up a table. That is why when loaded with that disc after that, the focus and tracking controls can get done with stability and the read performance can be improved on a layer-by-layer basis.

Furthermore, according to yet another preferred embodiment of the present invention, the range of allowable reflectances can be expanded, and therefore, the design margins of the respective storage layers (and that of the shallowest layer closest to the disc surface, among other things) can be increased. As a result, the material can be selected from a much broader range and the yield of optical discs can be increased. Consequently, the cost of making a multilayer optical disc can be cut down eventually.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIGS. 1(a) and 1(c) illustrate cross-sectional structures of a triple-layer disc and a quadruple-layer disc, respectively. And FIGS. 1(b) and 1(d) illustrate how the incident light is reflected from the respective storage layers of those multilayer optical discs.

FIG. 2 is a table summarizing various reflectance-read power settings for respective storage layers of a triple-layer disc.

FIG. 3A shows signal waveforms that are obtained from respective storage layers of a triple-layer disc in a situation where their reflectances are the same.

FIG. 3B shows signal waveforms that are obtained from the respective storage layers of a triple-layer disc before and after their read powers are controlled in a situation where their reflectances have varied.

FIG. 3C shows other signal waveforms that are obtained from the respective storage layers of a triple-layer disc before and after their read powers are controlled in a situation where their reflectances have varied.

FIG. 3D shows other signal waveforms that are obtained from the respective storage layers of a triple-layer disc before and after their read powers are controlled in a situation where their reflectances have varied.

FIG. 4 is a table summarizing various reflectance-standard read power settings for respective storage layers of single-layer, double-layer, and triple-layer BD-REs.

FIG. 5 is a table summarizing various reflectance-standard read power settings for respective storage layers of single-layer, double-layer, triple-layer and quadruple-layer BD-Rs.

FIG. 6 is a block diagram schematically illustrating a configuration for an optical disc drive as a first preferred embodiment of the present invention.

FIG. 7 is a block diagram illustrating a more detailed configuration for the optical pickup 103, the servo controller 106 and their surrounding members shown in FIG. 6.

FIGS. 8(a) and 8(b) illustrate the configuration and operation of the spherical aberration corrector shown in FIG. 7.

Portions (a), (b) and (c) of FIG. 9 illustrate what S-curve signals are obtained from a triple-layer disc as the objective lens inches toward the disc.

Portions (a), (b) and (c) of FIG. 10 illustrate what S-curve signals are obtained from a quadruple-layer disc as the objective lens inches toward the disc.

FIG. 11 is a flowchart showing the procedure of drawing up a read power table according to the first preferred embodiment of the present invention.

FIGS. 12(a) and 12(b) schematically illustrate standard power tables and read power tables to be stored for a quadruple-layer BD-R in a memory of an optical disc drive.

FIG. 13 schematically illustrates a read power table to be stored in a read power table storage area on an optical disc.

FIG. 14 is a flowchart showing the procedure of determining how many storage layers a given multilayer optical disc has according to the first preferred embodiment of the present invention.

Portions (a) through (d) of FIG. 15 show how the waveforms of respective signals vary while a focus finding operation is being performed on a quadruple-layer disc according to the first preferred embodiment of the present invention.

FIG. 16 is a flowchart showing the procedure of performing a focus finding operation on a quadruple-layer disc according to the first preferred embodiment of the present invention.

FIGS. 17A and 17B are flowcharts showing an exemplary procedure for performing a focus jump operation according to the first preferred embodiment of the present invention.

FIGS. 18A and 18B are flowcharts showing an alternative procedure for performing a focus jump operation according to the first preferred embodiment of the present invention.

### DETAILED DESCRIPTION OF PREFERRED EMBODIMENTS

An optical disc drive according to the present invention includes: a light source for emitting a light beam; an objective lens for converging the light beam; and a photodetector for detecting the light beam that has been reflected from an optical disc loaded. If the optical disc loaded is a multilayer optical disc with three or more storage layers, the optical disc drive of the present invention sets a read power for at least one of the storage layers to be lower than read power(s) for the other storage layers. As used herein, the “read power” means the optical power of a light beam emitted from the light source in order to read data from a storage layer.

A conventional optical disc drive uses, as a reference one, a read power for a storage layer that is most likely to suffer damage when irradiated with a read light beam, and performs a read operation on each of the other storage layers with that read power. On the other hand, according to the present invention, if the optical disc loaded is a multilayer optical disc with three or more storage layers, the read power is decreased for at least one of those storage layers. As a result, the intended reflected light intensity can be obtained from each of those storage layers with the damage that could be done by the read light beam minimized.

Also, according to the present invention, the optical disc loaded may be recognized to be a multilayer optical disc with three or more storage layers by disc type recognition, and then data is read with the read power optimized for each of those storage layers. However, before data starts to be read (e.g., while the type of the given optical disc is being recognized), that optical disc may be irradiated with a light beam that has the maximum read power defined by the standard. This is because while the type of a given optical disc is being recognized, usually no damage should be done by the read light beam.

If the optical disc loaded into the optical disc drive is a multilayer optical disc with three or more storage layers, the ratio of read powers for the respective storage layers may be either fixed for the same type of multilayer optical disc or changed adaptively to that multilayer optical disc loaded. Herein the same type of multilayer optical disc means the disc having the same physical structure which is defined by the disc type such as ROM/RE/R and the number of the storage layers.

In one preferred embodiment of the present invention to be described later, the ratio of the read powers for the respective storage layers is changed according to the ratio of the amplitudes of respective S-curves of a focus error signal that are obtained from the respective storage layers of the multilayer optical disc. In that case, the ratio of the read powers for the respective storage layers is changed so that the respective S-curves of the focus error signal obtained from the respective storage layers of the multilayer optical disc have amplitudes that fall within a preset range.

Hereinafter, preferred embodiments of an optical disc drive, read power setting method, multilayer disc type recognition method, focus finding method, and focus jump method according to the present invention will be described with reference to the accompanying drawings.

### Embodiment 1

### Triple-Layer Disc and Quadruple-Layer Disc

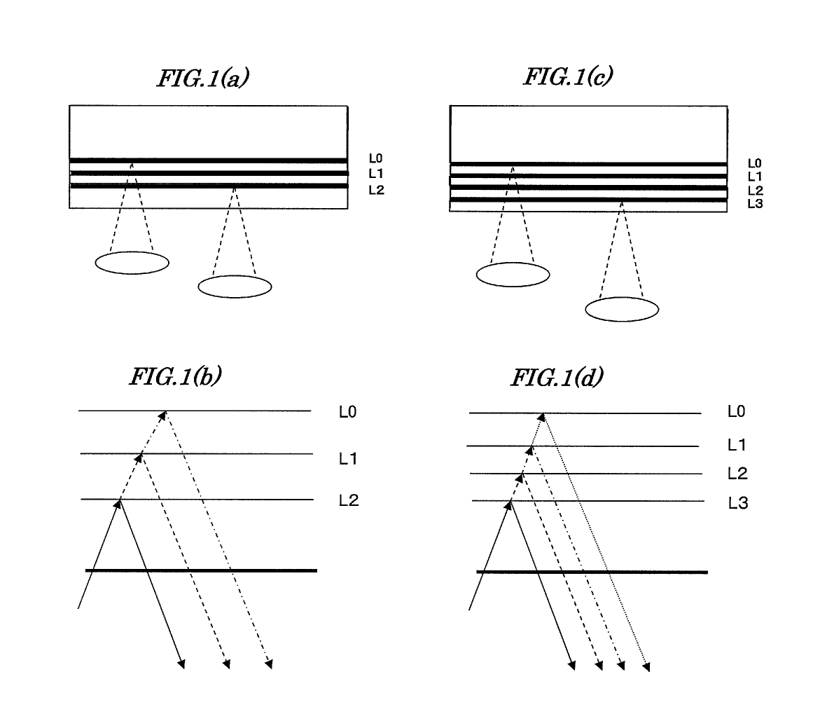

FIG. 1 schematically illustrates the cross-sectional structures of a triple-layer disc and a quadruple-layer disc, which are exemplary multilayer optical discs for use in preferred embodiments of an optical disc drive according to the present invention.

Specifically, FIG. 1(a) is a cross-sectional view of a triple-layer BD-RE disc, which shows how light beam spots are formed on L0 and L2 layers thereof. On the other hand, FIG. 1(b) is a cross-sectional view of a quadruple-layer BD-RE disc, which shows how light beam spots are formed on L0 and L3 layers thereof.

The optical pickup of this optical disc drive includes a light source for emitting a light beam, an objective lens for converging the light beam, and a photodetector for detecting the light beam that has been reflected from the optical disc. By moving the objective lens either toward or away from the optical disc, the focus position of the light beam that has passed through the objective lens moves along the optical axis. As used herein, the “light beam spot” corresponds to the focus position of the light beam that has been converged by the objective lens. To write data on a target storage layer or read data from that storage layer, the light beam needs to be focused so that the light beam spot is located right on the target storage layer. In the following description, to shift the light beam spot from one of multiple storage layers of a given multilayer optical disc to another will be referred to herein as “focus jump”.

As shown in FIG. 1(a), when the light beam spot needs to be located on the deepest L0 layer (i.e., when the light beam needs to be focused on the L0 layer), the light beam also needs to be transmitted through the L1 and L2 layers, which are located shallower than the L0 layer. Also, when the light beam is focused on the L0 layer, the cross sections of the light beam passing through the L1 and L2 layers are much greater as measured on the L1 and L2 layers than that of the light beam spot on the L0 layer.

FIG. 1(b) schematically illustrates the reflected light beams in a situation where a light beam spot needs to be formed on the L0 layer of a triple-layer BD-RE disc, which is located closest to the substrate (i.e., located deepest under the disc surface). In that case, as indicated by the solid, dashed and one-dot chain arrows, the light beam that has come through the objective lens in the optical pickup is transmitted through the L2, L1 and L0 layers in this order (i.e., through the shallowest L2 layer first), thereby forming a light beam spot on the L0 layer. That is why every time the light beam passes through a storage layer, the intensity of the light beam decreases according to its transmittance. That is to say, as viewed from the optical pickup, the closer to the substrate the target storage layer is, the lower the intensity of the light incident on that storage layer will be. For that reason, the read power for the L0 layer should be set to be higher than the one for the L2 layer. Conversely, when a light beam spot needs to be formed on the L2 layer that is located closest to the disc surface, the incoming light has only to be transmitted through just the cover layer and its intensity hardly decreases. Thus, a sufficiently high reflected light intensity can be achieved easily but the transmittance still needs to be increased so much as to transmit the light beam efficiency enough to make that light beam reach the L0 layer closest to the substrate. If the transmittance is increased, then the reflectance decreases. In this case, however, as the intensity of the light is hardly decreased by the shallowest layer, the optical pickup is designed so that there is little difference in reflectance between the shallowest L2 layer and the deeper L0 and L1 layers.

Likewise, FIG. 1(d) schematically illustrates a situation where a light beam spot needs to be formed on the L0 layer of a quadruple-layer BD-R disc, which is located closest to the substrate. In that case, the light beam that has come through the objective lens in the optical pickup is also transmitted through the L3, L2, L1 and L0 layers in this order (i.e., through the shallowest L3 layer first). That is why every time the light beam passes through a storage layer, the intensity of the light beam decreases. For that reason, the read power for the L0 layer should be set to be higher than the one for the L3 layer. Conversely, when a light beam spot needs to be formed on the L3 layer, the intensity of the incoming light hardly decreases. Thus, a sufficiently high reflected light intensity can be achieved easily but the light beam transmitted should reach the L0 layer efficiently. If the transmittance of one storage layer is increased, then its reflectance decreases. With this fact taken into account, the optical pickup is designed so that there is little difference in reflectance between the shallower L3 and L2 layers and the deeper L1 and L0 layers.

If the reflectances of respective storage layers have already been appropriately adjusted in a given multilayer optical disc, there is no need for an optical disc drive to control the read power on a storage layer basis in the first place. For that reason, no optical disc drive has ever been required to change the read power for each storage layer. Nevertheless, if the reflectances of respective storage layers of a multilayer optical disc should be controlled precisely, then the cost of manufacturing such multilayer optical discs should be higher than usual. Also, in an actual multilayer optical disc, the reflectance of any of its storage layers could vary from its target value. In view of these considerations, according to the present invention, it is the optical disc drive that controls the read powers so that data can be read appropriately from any storage layer of a multilayer optical disc even if the reflectance of that storage layer has varied from the designed value.

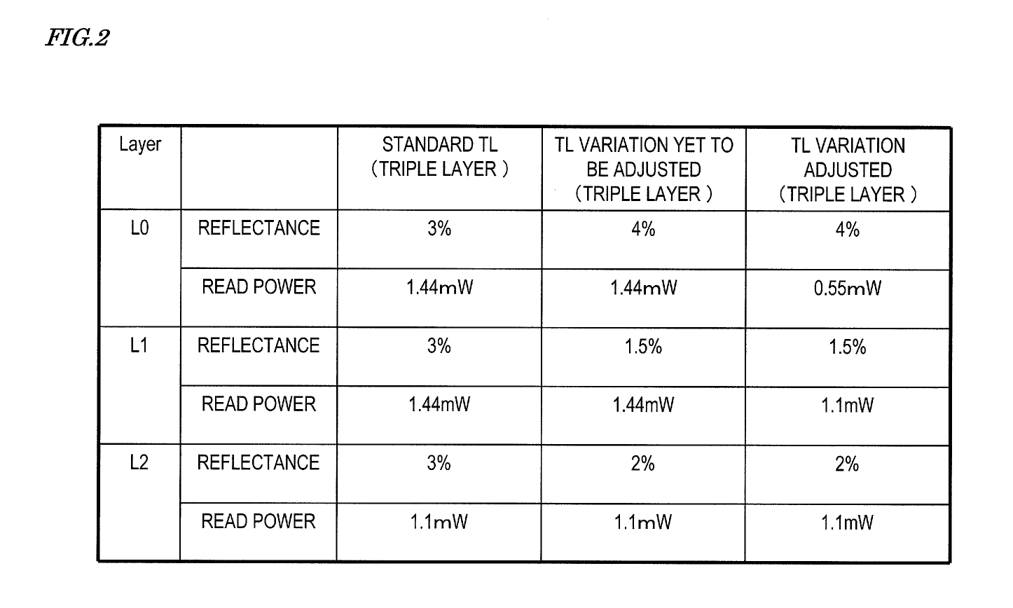

FIG. 2 is a table summarizing various reflectance-read power settings for respective storage layers of a triple-layer optical disc. As used herein, the “reflectance of each storage layer” does not mean the reflectance of the storage layer itself but is represented by the ratio of the intensity Pₒᵤₜ of the light reflected from a storage layer of interest to the intensity Pᵢₙ of the light that has been incident on an optical disc. That is to say, the reflectance of the storage layer of interest can be represented by the Pₒᵤₜ/Pᵢₙ ratio. The reflectance thus defined means the ratio of the intensity of the light returning from the storage layer of interest to the optical pickup (or the photodetector) to that of the incident light.

In the Table shown in FIG. 2, “standard TL” refers to an optical disc, of which the storage layers have the same reflectance. On the other hand, “TL variation yet to be adjusted” refers to an optical disc, of which the storage layers have mutually different reflectances. The read power applied to each storage layer of the “standard TL” disc agrees with what is applied to its counterpart of the “TL variation yet to be adjusted” disc. On the other hand, the read power applied to each storage layer of a “TL variation adjusted” disc has already been adjusted.

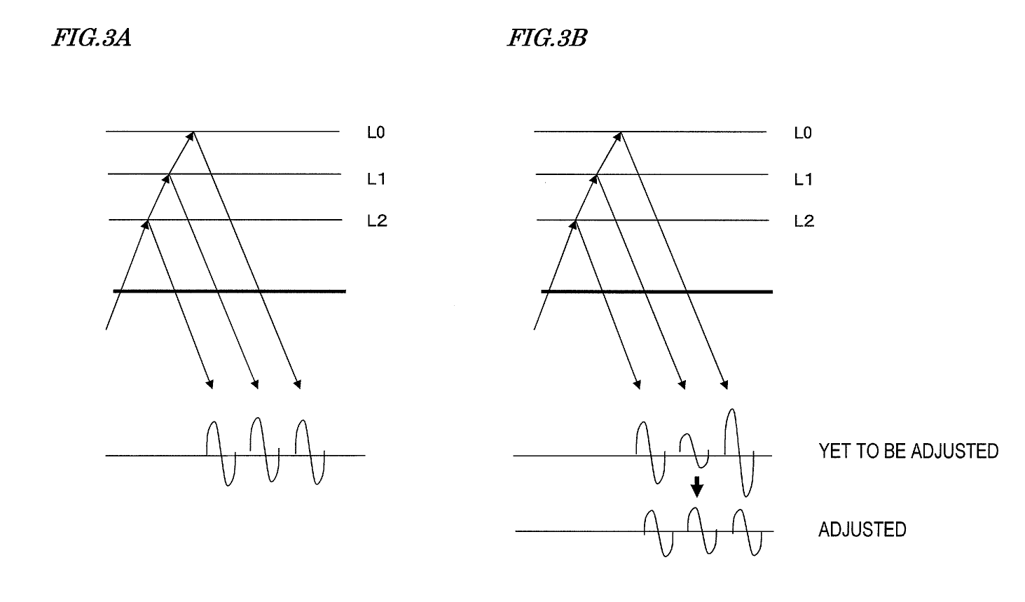

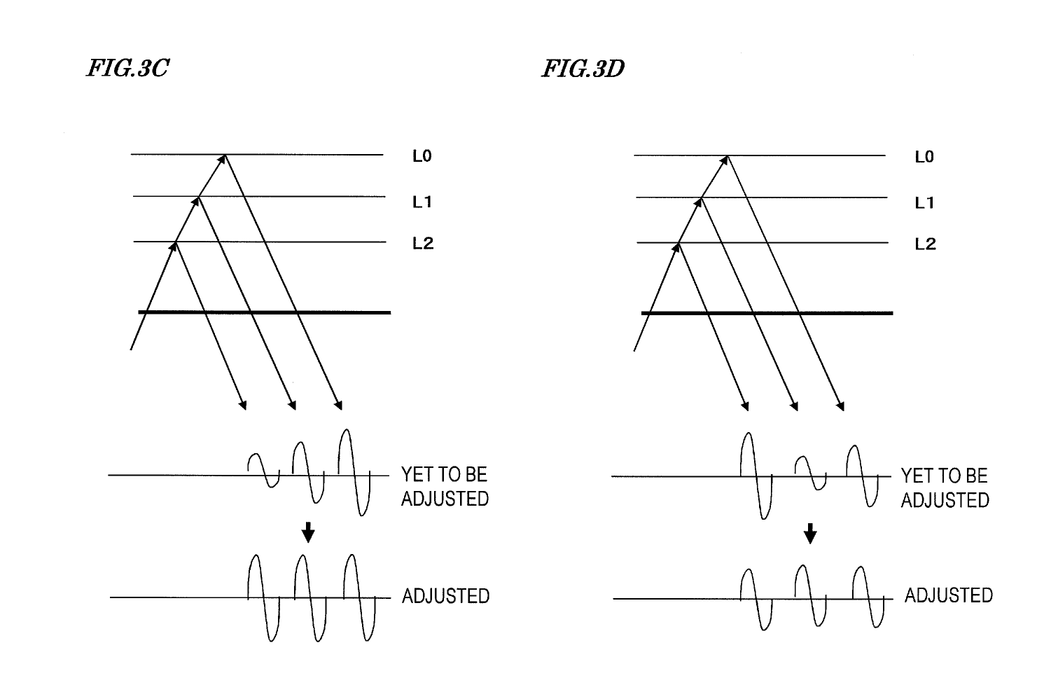

In the example shown in FIG. 2, as for the “standard TL” optical disc with a standard reflectance, read powers of 1.44 mW, 1.44 mW and 1.1 mW are set for the L0, L1 and L2 layers, respectively. In that case, the S-curves of a focus error signal that are obtained from the respective storage layers have the same amplitude between the respective storage layers as shown in FIG. 3A.

The light incident on the L2 layer, which is located closer to the disc surface than any other storage layer, is more intense than the light reaching any other layer of the same disc. That is why to prevent such intense light from doing significant damage on the shallowest L2 layer, it is preferred that the read power for the L2 layer be set to be lower than the read power for the L0 and L1 layers. For that reason, in the example shown in FIG. 2, the read powers for the L0 and L1 layers are both set to be 1.44 W, whereas the read power for the L2 layer is set to be 1.1 mW.

Meanwhile, the L0 layer, which is located farther away from the disc surface than any other storage layer of the same disc, does not have to transmit the incoming light at all. That is why a reflective film could be provided for the L0 layer in order to increase the intensity of the light reflected from the L0 layer. Consequently, as far as the L0 layer is concerned, it is easy to minimize the variation in reflectance and achieve sufficiently high reflected light intensity. As for the intermediate L1 layer between those shallowest and deepest layers, the reflectance of the L1 layer is variable more easily than in the deepest L0 layer and could even vary more significantly than in the shallowest L2 layer.

The present inventors discovered that when an optical disc, of which the respective storage layers had had their reflectances varied from the reflectance (of 3%) of a standard triple-layer disc, was irradiated with light with the read power for the standard triple-layer disc, the following problems would arise.

FIG. 3B shows S-curves obtained with the read power yet to be controlled as shown in FIG. 2 and S-curves obtained with the controlled read power shown in FIG. 2. In this example, with the read power yet to be controlled, the S-curves obtained from the respective storage layers have varying amplitudes. If the light beam should be focused on one of these storage layers or if the focus should be shifted from one layer to another as it is (i.e., without controlling the read power), then a failure could occur.

On the other hand, if the read power is controlled appropriately, an S-curve signal with substantially the same amplitude can be obtained from each of the three storage layers. As a result, the chances of causing a focus error or focus jump failure are slim, no matter which of the three is the target. In addition, with the controlled read power, a read signal of quality can also be obtained.

If the S curves obtained from the respective storage layers have varying amplitudes, the read powers for those storage layers are controlled and changed into ones that do fall within the range defined by the standard (which will be referred to herein as a “standard range”) and that can equalize the S-curve amplitudes with each other by maximizing their amplitudes. For these purposes, the difference in S-curve amplitude may be ironed out by performing the following procedure of equalizing the S-curve amplitudes with each other. First of all, in order to equalize smaller S-curve amplitudes with the largest one, read powers for storage layers with smaller S-curve amplitudes are increased within the standard range. If the smaller S-curve amplitudes can be equalized with the largest one by increasing the read powers, then this read power control process ends. However, if the smaller S-curve amplitudes cannot be equalized with the largest one even by increasing the read powers to the limit of the standard range, then the processing step of equalizing the S-curve amplitudes with the second largest one is carried out. In this manner, the S-curve amplitudes can be equalized with each other.

By applying this procedure to an optical disc with the storage layers shown in FIG. 2, the read power is controlled so that an S-curve signal with substantially the same amplitude can be obtained from each storage layer. In the example shown in FIG. 2, the read power yet to be controlled for the L2 layer is already the upper limit of the standard range. That is why the read power for the L2 layer cannot be increased from the one yet to be controlled as shown in FIG. 3B. For that reason, in this case, the read powers should be controlled so as to equalize larger S-curve amplitudes with the smallest one. As a result, the controlled read powers are set to be 0.55 mW, 1.1 mW and 1.1 mW for the L0, L1 and L2 layers, respectively.

FIG. 3C schematically illustrates another example. In this example, when the read powers are yet to be controlled, an S-curve with the largest amplitude is obtained from the L0 layer. And the smaller S-curve amplitudes of the other L1 and L2 layers can be equalized with the largest one of the L0 layer by raising the read powers for the L1 and L2 layers within the standard range.

FIG. 3D schematically illustrates yet another example. In this example, when the read powers are yet to be controlled, an S-curve with the largest amplitude is obtained from the L2 layer. However, to equalize the smaller S-curve amplitudes of the L0 and L1 layers with the largest one of the L2 layer, the read power for the L0 or L1 layer should be increased to beyond the upper limit of the standard range. That is why to equalize the S-curve amplitudes of the L1 and L2 layers with the second largest one of the L0 layer, the read power for the L1 layer is increased. As a result, the S-curve amplitude of the L1 layer can be equalized with that of the L0 layer by increasing the read power for the L1 layer within the standard range. Likewise, by decreasing the read power for the L2 layer within the standard range, the S-curve amplitude of the L2 layer can also be equalized with that of the L0 layer.

As described above, in determining which of three or more storage layers has an S-curve amplitude with which those of the other storage layers should be equalized, the read powers for the respective storage layers are controlled to prevent the read power for any of those layers from exceeding the standard range and to maximize the S-curve amplitude equalized.

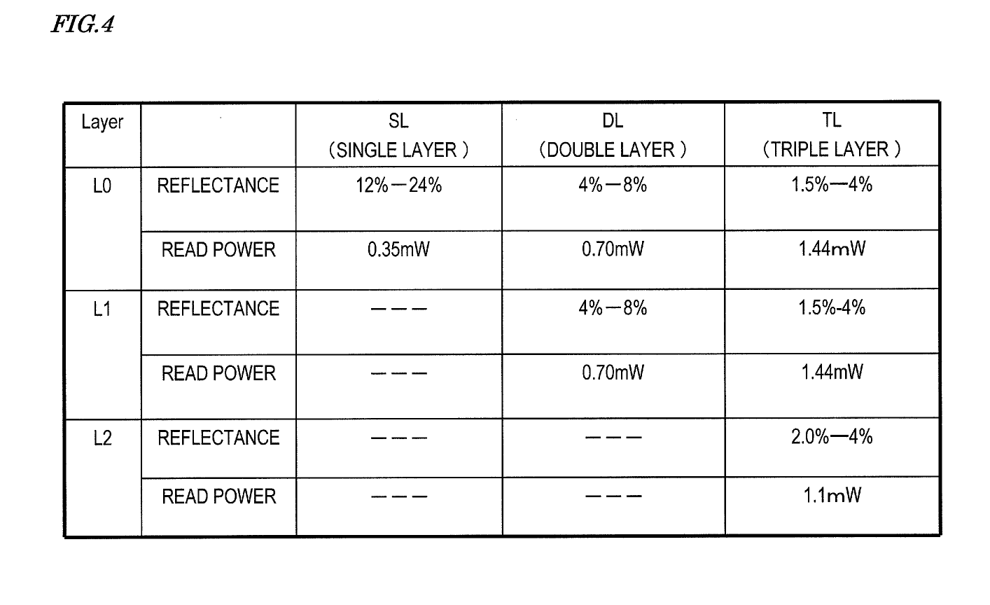

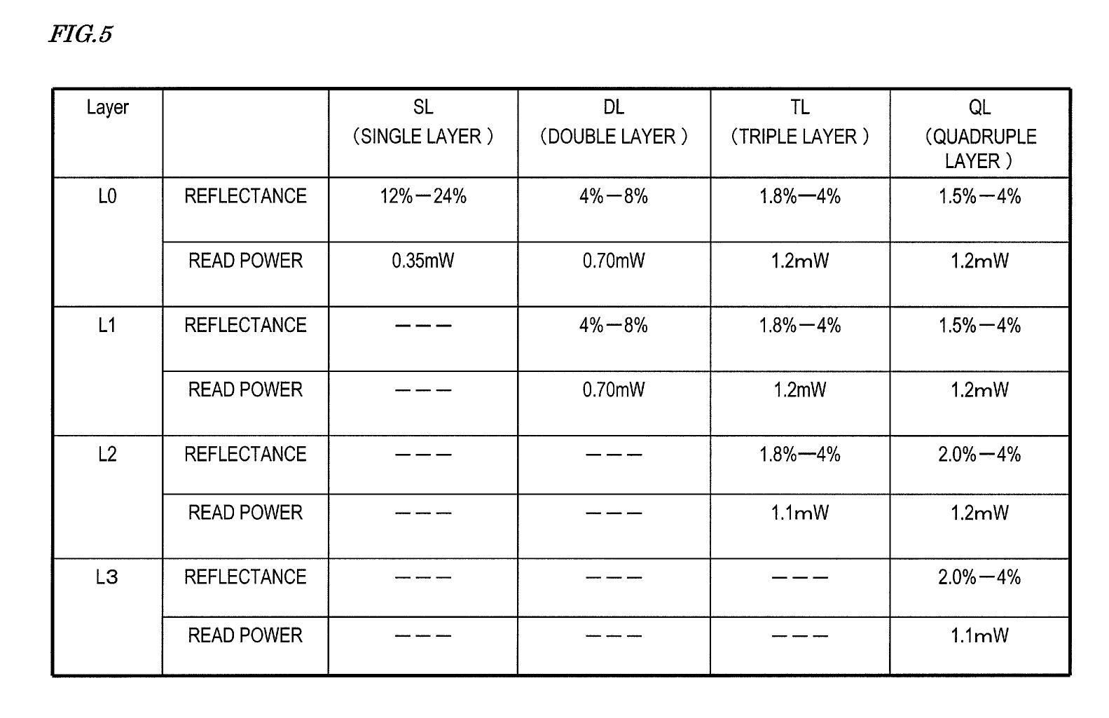

FIG. 4 is a table summarizing various reflectance-read power settings for respective storage layers of single-layer, double-layer, and triple-layer BD-REs. On the other hand, FIG. 5 is a table summarizing various reflectance-read power settings for respective storage layers of single-layer, double-layer, triple-layer and quadruple-layer BD-Rs. The read power values shown in these tables are standard settings for these types of optical discs and will be referred to herein as “standard read powers”.

In FIGS. 4 and 5, SL, DL, TL and QL stand for a “single-layer disc”, a “double-layer disc”, a “triple-layer disc” and a “quadruple-layer disc”, respectively. FIG. 4 says the reflectance is “1.5%-4%” for the L0 layer of a triple-layer disc, which means that the triple-layer disc is designed and manufactured so that the reflectance of its L0 layer falls within the range of 1.5% to 4%.

In the preferred embodiment described above, the optical disc drive of the present invention operates so that the read power used for the shallowest layer of a triple- or quadruple-layer disc (i.e., their storage layer located closest to the disc surface) is different from the one used for the other storage layers. However, the present invention is in no way limited to that specific preferred embodiment. Alternatively, a different standard read power may also be set for each of those storage layers.

### Configuration for Optical Disc Drive

Next, an exemplary configuration for an optical disc drive according to this preferred embodiment will be described.

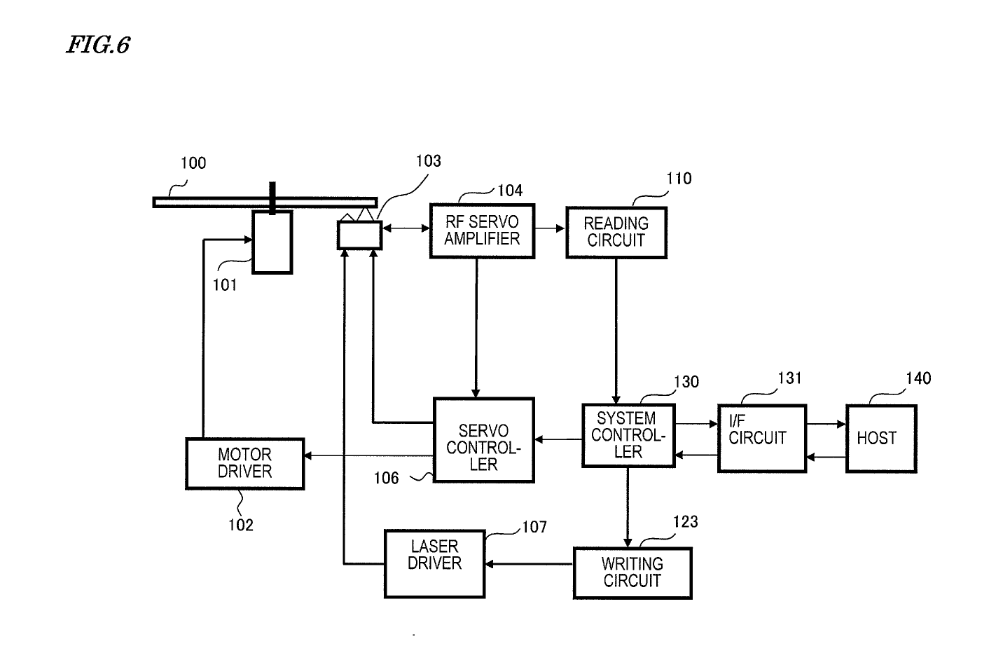

FIG. 6 is a block diagram schematically illustrating a configuration for the optical disc drive of this preferred embodiment.

The optical disc drive of this preferred embodiment includes an optical pickup 103, which includes an optical system for converging a light beam onto the optical disc 100, a photodetector for detecting the light that has been reflected from the optical disc, and a laser diode as a light source. The optical disc drive further includes a motor driver 102 for driving an optical disc motor 101 with the number of revolutions of the motor set to be a predetermined one, a servo controller 106 for controlling the operation of the optical pickup 103, a reading circuit 110 for reading an information signal that has been detected by the optical pickup 103 on the optical disc 100, and a writing circuit 123 for writing the information on the optical disc 100 by getting pulsed laser beams emitted from a laser diode by the laser driver 107 by a predetermined modulation technique according to the information to be written.

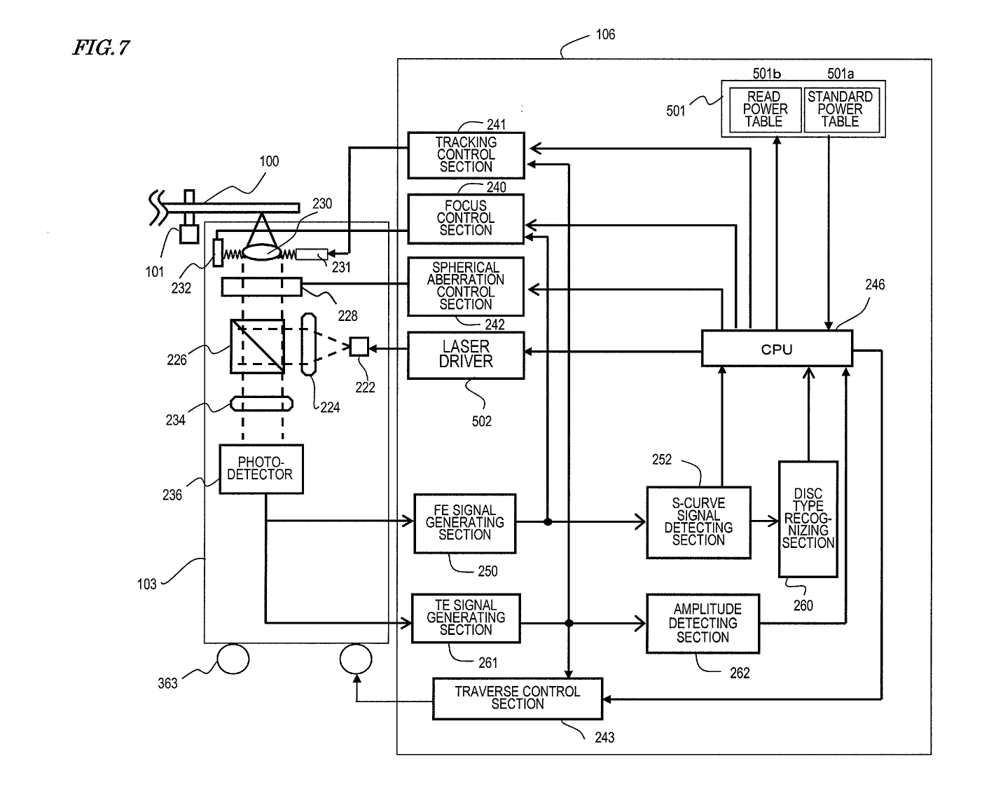

The optical pickup 103 irradiates the optical disc 100, which has been mounted on the optical disc motor 101, with a converged laser beam. An RF servo amplifier 104 generates an electrical signal based on the light that has been reflected from the optical disc 100. The servo controller 106 performs a focus control and a tracking control on the optical disc 100 that has been mounted on the optical disc motor 101. The servo controller 106 includes a disc type recognizing section 260 (see FIG. 7) for determining, by irradiating the optical disc 100 with a light beam using the light source and lenses, whether the given optical disc 100 is a BD or not, and whether the disc 100 has only one layer, two layers, or more than two storage layers.

The reading circuit 110 gets the electrical signal, which has been supplied from the RF servo amplifier 104, equalized by a waveform equalizer, for example, thereby generating an analog read signal, which is converted into a digital signal and then synchronized with a read clock signal (i.e., a reference clock signal) by a PLL. In this manner, the data can be extracted. Thereafter, the data is subjected to predetermined demodulation and error correction and then supplied to a system controller 130, which transfers the data to a host 140 by way of an I/F circuit 131.

Then, the writing circuit 123 adds a header and redundant bits for error correction to the data, modulates it into a predetermined modulation pattern (by predetermined modulation technique), and then gets pulsed laser beams emitted from the laser diode in the optical pickup 103 by the laser driver 107 in order to write the information that has been supplied from the host 140 by way of the I/F circuit 131 on the optical disc 100. By varying the reflectance of the recording material (such as an organic material or a phase change material) of the optical disc 100 according to the degree of intensity modulation of the laser beam that has been incident on the optical disc 100, information is written as ones or zeros.

### Configuration for Optical Pickup

FIG. 7 is a block diagram illustrating, in further detail, the optical pickup 103, the servo controller 106 and their surrounding sections shown in FIG. 6. These components will be further described with reference to FIG. 7.

First of all, the configuration of the optical pickup will be described. The optical pickup 103 includes a light source 222, a coupling lens 224, a polarization beam splitter 226, a spherical aberration corrector 228, an objective lens 230, a tracking actuator 231, a focus actuator 232, a condenser lens 234 and a photodetector 236.

The light source 222 is implemented as a semiconductor laser diode for emitting a light beam. Only one light source 222 is illustrated in FIG. 7 for the sake of simplicity. Actually, however, the light source may include three semiconductor laser diodes that emit light beams with mutually different wavelengths. More specifically, the single optical pickup preferably includes multiple semiconductor laser diodes for emitting light beams with mutually different wavelengths for CDs, DVDs and BDs, respectively.

The coupling lens 224 transforms the light beam that has been emitted from the light source 222 into a parallel beam. The polarization beam splitter 226 reflects the parallel beam that has come from the coupling lens 224. Since the position of the semiconductor laser diode in the light source 122 and the wavelength of the light beam to be emitted change according to the type of the optical disc, the best configuration of the optical system also changes according to the type of the optical disc 100. That is why the configuration of the optical pickup 103 is actually more complicated than the illustrated one.

The objective lens 230 converges the light beam that has been reflected from the polarization beam splitter 226.

The actuator 232 controls the position of the objective lens 230 to a predetermined one based on the FE and TE signals. In reading or writing data from/on a storage layer of the optical disc 100, the focal point of the light beam that has been converged by the objective lens 230 is located on the storage layer, thereby forming a light beam spot on the storage layer. Only one objective lens 230 is shown in FIG. 7. Actually, however, multiple objective lenses 230 need to be provided and used selectively according to the type of the given optical disc 100. In reading and writing data, the focus servo and tracking servo are turned ON and the position of the objective lens 230 is controlled precisely so that the focal point of the light beam follows the target track on the storage layer.

This preferred embodiment is characterized by the method of determining how many storage layers a given BD has. Although the optical pickup shown in FIG. 7 is illustrated as having a simple configuration, the optical pickup may actually have additional laser diodes and lenses other than the laser diode 222 and lens 230 dedicated to BDs.

After the optical disc drive has been loaded with the BD disc 100 and before the operation of reading or writing data is started, a disc type recognition operation is carried out to determine whether the given BD is a multilayer disc or not, and (if the answer is YES), how many storage layers that multilayer disc has. When the disc type recognition operation is carried out, the position of the objective lens 230 is changed significantly along the optical axis by the focus actuator 232. The disc type recognition can also be made without rotating the BD disc 100.

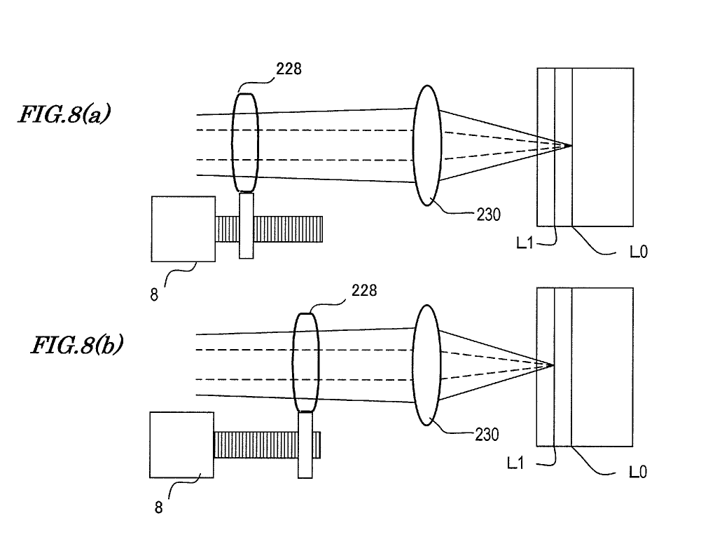

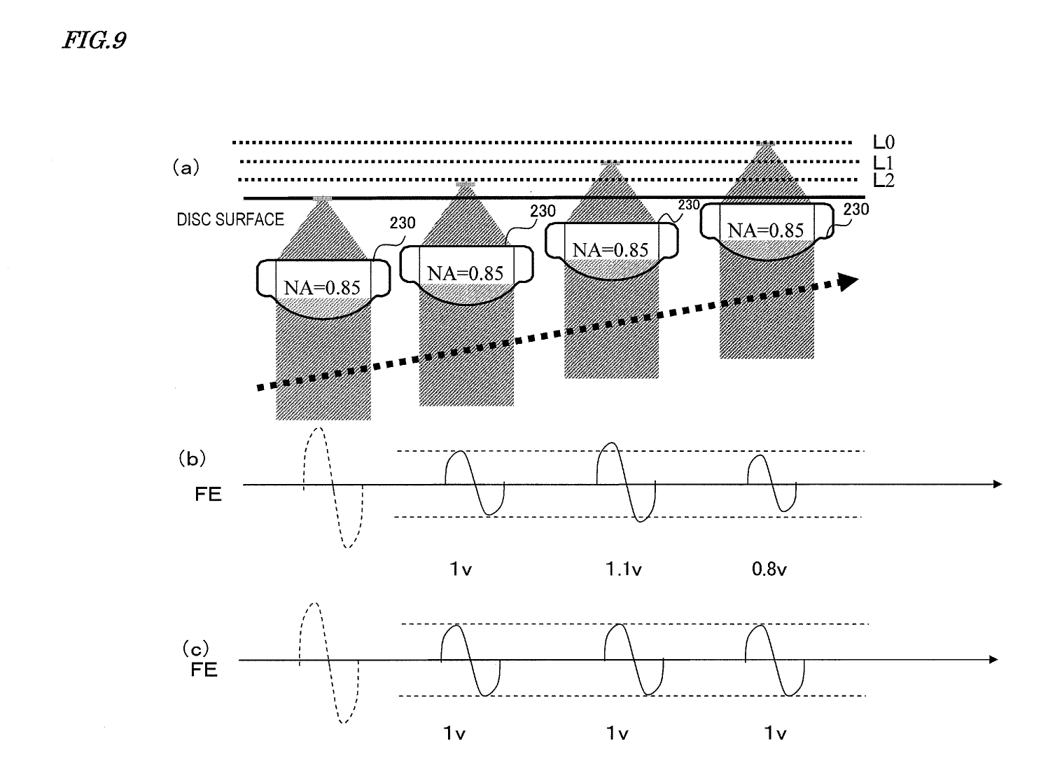

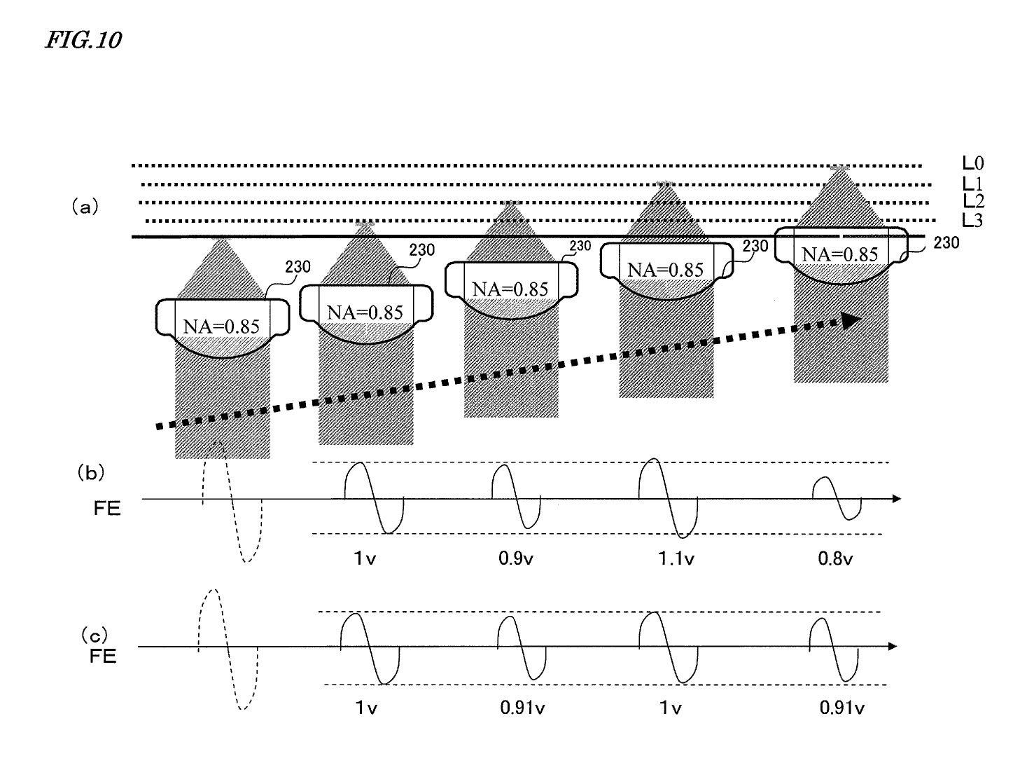

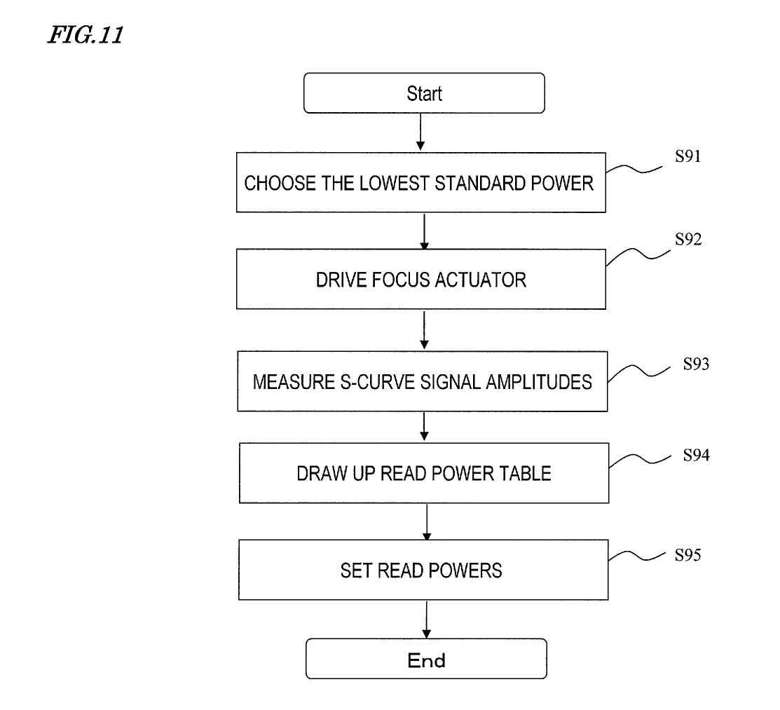

The spherical aberration corrector 228 may include a correction lens (see FIG. 8), of which the position can be changed in the optical axis direction, for example, and may have a beam expander structure in which the spherical aberration state (corresponding to the magnitude of correction) can be changed by adjusting the position of the correction lens. However, the spherical aberration corrector 228 does not have to have such a beam expander structure, but may also have a configuration for correcting the aberration using a liquid crystal element or a hinge, for example.

The light beam that has been reflected from the storage layer of the BD disc 100 passes through the objective lens 230, spherical aberration corrector 228 and polarization beam splitter 226 and then enters the condenser lens 234, which converges, onto the photodetector 236, the light beam that has been reflected from the optical disc 100 and then transmitted through the objective lens 230 and the polarization beam splitter 226. On receiving the light that has been transmitted through the condenser lens 234, the photodetector 236 converts the optical signal into various electrical signals (e.g., current signals). The photodetector 236 may be a quadruple photodetector with four photosensitive areas, for example.

The optical pickup 103 can be driven by a traverse motor 363 so as to move over a wide range in the radial direction of the optical disc 100.

### Configuration for Servo Controller

The servo controller 106 shown in FIG. 7 includes a focus control section 240, a tracking control section 241, a spherical aberration control section 242 and a traverse driver 243. Using these circuit sections, a CPU 246 controls various kinds of operations to be performed by the optical pickup 103. The servo controller 106 further includes an FE signal generating section 250, an S-curve signal detecting section 252, a TE signal generating section 261, an amplitude detecting section 262, and a disc type recognizing section 260.

The focus control section 240 drives the focusing actuator 232 in accordance with the instruction given by the CPU 246, thereby moving the objective lens 230 to any arbitrary position along the optical axis. Also, in response to the FE signal supplied from the FE signal generating section 250, the focus control section 240 performs a focus control so that the light beam spot on the optical disc 100 has a predetermined converging state.

On the other hand, the tracking control section 141 drives the tracking actuator 231, thereby moving the objective lens 230 to any radial location on the optical disc 100, and also performs a tracking control so that the light beam spot on the optical disc 100 follows the tracks in response to a TE signal supplied from the TE signal generating section 261.

In accordance with the signals supplied from the CPU 246 and the TE signal generating section 261, the traverse control section 243 controls the traverse motor 363, thereby moving the optical pickup 103 to a target radial location on the optical disc 100.

In accordance with the instruction given by the CPU 246, the spherical aberration control section 242 controls the spherical aberration corrector 228 into a predetermined setting. Specifically, in response to the control signal supplied from the spherical aberration control section 242, the stepping motor 8 shown in FIG. 8 operates so as to move the aberration correction lens 228 to a predetermined position, which is defined by the cover layer thickness of the first or second layer if the given optical disc is a double-layer disc. By changing the position (i.e., the position in the optical axis direction) of the aberration correction lens 228, the spherical aberration state of the light beam can be regulated. The same operation or function can be done in a similar manner in any of the quadruple- to sixteen-layer optical disc or even in a twenty-layer optical disc.

The FE signal generating section 250 generates an FE signal based on the electrical signals that have been supplied from multiple photosensitive areas of the photodetector section 236. The FE signal may be generated by any method. Examples of methods for generating the FE signal include an astigmatism method, a knife edge method or even a spot sized detection (SSD) method. The output FE signal of the FE signal generating section 250 is supplied to the S-curve signal detecting section 252, which sets a predetermined detection threshold value in accordance with the instruction given by the CPU 246.

The TE signal generating section 261 generates a TE signal based on the electrical signals that have been supplied from multiple photosensitive areas in the photodetector section 236. As for a recordable optical disc with land and groove tracks such as a BD-R or a BD-RE, the TE signal is usually generated by push-pull detection method. On the other hand, as for a read-only optical disc with embossed information pre-pits such as a BD-ROM, the TE signal is usually generated by some phase difference detection method. However, the method of generating a TE signal is not particularly limited by any tracking method.

The TE signal is output from the TE signal generating section 261 to the amplitude detecting section 262, which measures and detects the amplitude of a sinusoidal wave signal, which is generated when a track is crossed, with a predetermined spherical aberration setting.

The S-curve signal detecting section 252 determines whether or not the level of the FE signal exceeds a predetermined threshold value while the objective lens 230 is moving along the optical axis to make a focus search, thereby detecting an S-curve signal. And the disc type recognizing section 260 counts the S-curve signals that have been detected by the S-curve signal detecting section 252, thereby determining how many storage layers the given multilayer optical disc has.

The CPU 246 also retrieves the read power table 501a from a memory circuit 501 and then optimizes and updates the table 501a into a read power table 501b with or without adding data to it. Also, by reference to the read power table 501b updated, the CPU 246 changes the current (or voltage) supplied to the laser driver 502 so that the semiconductor laser diode 222 in the optical pickup 103 outputs a predetermined power.

Specifically, the CPU 246 writes standard powers for respective storage layers of a multilayer optical disc, which have been adjusted to a standard optical disc during the manufacturing process of an optical disc drive, for example, on a standard read power table 501a, which may be implemented as an EEPROM or a flash memory, for example. And when the user loads the optical disc drive with an optical disc in order to use it actually, the CPU 246 gets the amplitude of the S-curve signal measured on a layer-by-layer basis by the S-curve signal detecting section 252, determines the power by the amplitude measured, draws up a table of read powers for the respective storage layers, and then either updates the read power table 501b (which may be implemented as a DRAM) or just adds new data to it. After that, the CPU 246 retrieves the read power table 501b and changes the target current value of the laser driver 502 so as to adjust the read power to that read power table 501b. In this manner, the optical disc drive gets ready to access a predetermined layer of the multilayer optical disc loaded and then read data from that layer when the loading process is done.

### Draw Up Read Power Table and Set Read Power

Next, it will be described with reference to FIG. 11 how to set the read power. FIG. 11 is a flowchart showing how to set read powers for respective storage layers of a multilayer optical disc. In this example, the optical disc loaded is supposed to be a triple-layer disc.

This read power setting method includes the processing step of drawing up a tale of read powers, which will make the FE signal obtained from each of the storage layers of a multilayer optical disc have a predetermined amplitude either during the adjustment process of the optical disc drive or during the disc loading process.

As for a triple-layer BD-RE, a standard power for its L0 and L1 layers is defined to be 1.44 mW and a standard power for its L2 layer is defined to be 1.1 mW as shown in FIG. 4.

First of all, in Step S91, the read power is set to be 1.1 mW, which is the lowest one of the standard powers for the respective storage layers of a triple-layer BD-RE shown in FIG. 4.

Next, in Step S92, while the light beam is still emitted from the laser diode with the read power of 1.1 mW, the focus actuator 232 is driven. As a result, the objective lens 230 is brought either toward, or away from, the optical disc to move to any arbitrary position. As the objective lens 230 moves along the optical axis in this manner, the focus position of the light beam converged by the objective lens 230 moves perpendicularly to the surface of the optical disc. And when the focus position of the light beam passes any of the storage layers of the optical disc, one of the S-curve signals shown in FIG. 9 appears on the FE signal. As for a triple-layer disc, four S-curve signals are usually detected at the disc surface and at the L2, L1 and L0 layers thereof, respectively.

Generally speaking, a multilayer optical disc is ideally designed so as to make the reflectances of its respective storage layers equal to each other. Actually, however, due to some variations that inevitably arise during the manufacturing process or some difference in material property between the lots, the reflectances could vary within the ranges in the table shown in FIG. 4. And if the reflectances of those storage layers are significantly different from each other, the S-curve signals obtained from the respective storage layers will have mutually different amplitudes as shown in portion (b) of FIG. 9, even in a situation where the optical disc is irradiated with a light beam with a constant read power of 1.1 mW. Then, in Step S93, to measure those amplitude values, the FE signal is converted by an A/D converter into a digital signal, which is then supplied to the S-curve signal detecting section 252 (which is implemented as a DSP), thereby detecting the peaks.

When an FE signal is detected using a threshold value, the FE signal is detected not just by measuring the amplitude of either half of the FE signal but also by comparing the local maximum and minimum values of that FE signal to each other. By turning the polarity of the FE signal into positive only using an absolute value circuit, for example, it can be determined that when either a local minimum value or a local maximum value is detected, an S-curve signal has been detected. If an S-curve signal is detected based on at least one of the local minimum and local maximum values thereof, the S-curve signal can still be detected even when the S-curve signal has an asymmetric shape due to the influence of spherical aberration or astigmatism.

It should be noted that in double- to quadruple-layer discs currently available, the amplitudes of S-curve signals decrease only a little due to spherical aberrations, which will hardly affect the processing step of drawing up a table of read powers. That is why to save the time that is usually spent changing the spherical aberration, the layer on which the light beam needs to be focused on first may be set to be the position at which the spherical aberration is minimized. However, as the number of storage layers stacked in a single optical disc further increases in the near future, there could be a significant difference in the amplitude of the S-curve signal due to spherical aberrations between the shallowest and deepest layers of the optical disc. Or as the optical disc drive and optical pickup are further downsized, its photodetector could become even smaller. In that case, the influence produced by minimizing the spherical aberration at a particular storage layer would be no longer negligible. Then, by measuring the amplitudes of the S-curve signals with the spherical aberration adjusted to an intermediate position between the shallowest and deepest layers, the influence of the spherical aberration can be reduced. Also, as will be described later, the amplitudes of the S-curve signals may also be measured with the spherical aberration changed on a layer-by-layer basis.

FIGS. 9 and 10 are schematic representations illustrating where the objective lens 230 passes during the focus search operation and showing what S-curve signals are generated when the light beam spot goes through the respective layers of a multilayer BD disc. After the amplitudes of the respective S-curve signals of the multiple storage layers have been measured, a read power table that makes those amplitude values equal to each other is drawn up in Step S94 shown in FIG. 11. In this preferred embodiment, if the amplitudes of the respective S-curve signals of the L2, L1 and L0 layers are 1 v, 1.1 v and 0.8 v, respectively, as shown in portion (b) of FIG. 9, then the S-curve signal amplitude and the read power of the L2 layer (which are 1 v and 1.1 mW, respectively) may be used as reference values to set read powers for the L1 and L0 layers to be:

1.1×(1/1.1)=1 mW and

1.1×(1/0.8)=1.375 mW, respectively,

so that the S-curve signals obtained from the respective storage layers have an amplitude of 1 v.

Then, the CPU 246 stores these read powers on the read power table 501b in the memory section 501. In addition, the memory section 501 also stores the maximum read powers, at or under which no damage would be done on the L0, L1 and L2 layers shown in FIG. 4 by the read light beam, on the standard power table 501a. If the read powers that have been set while the amplitudes of the S-curve signals are measured as described above are greater than those maximum standard powers, then the read powers stored on the standard power table 501a may be defined to be the upper limits. In this manner, it is possible to prevent too intense a read light beam from destroying the data already stored.

Finally, in Step S95, by reference to the read powers stored on the read power table 501b, a read power is set for a predetermined layer of the given optical disc. The read power that has been set in this processing step S95 will be used in focusing the light beam on a target storage layer, determining how many storage layers the given multilayer optical disc has, and shifting the focus from one storage layer to another as will be described later. If the read powers on the read power table 501b are used adaptively to the respective storage layers, then the resultant S-curve signals will have the amplitudes as shown in portion (c) of FIG. 9.

Next, it will be described what if the optical disc loaded is a quadruple-layer BD-R. As for a quadruple-layer BD-R, a standard power for its L0, L1 and L2 layers is defined to be 1.2 mW and a standard power for its L3 layer is defined to be 1.1 mW as shown in FIG. 5. First of all, in Step S91, the read power is set to be 1.1 mW, which is the lowest one of the standard powers for the respective storage layers of a quadruple-layer BD-R shown in FIG. 5.

Subsequently, in Step S92, the focus actuator 232 is driven with the read power of 1.1 mW and the objective lens 230 is moved up and down. Then, the FE signal will have S-curves such as the ones shown in FIG. 10. As for a quadruple-layer disc, five S-curve signals are usually detected at the disc surface and at the L3, L2, L1 and L0 layers thereof, respectively.

Just like the triple-layer disc described above, a quadruple-layer disc is also ideally designed so as to make the reflectances of its respective storage layers equal to each other. Actually, however, due to some variations that inevitably arise during the manufacturing process or some difference in material property between the lots, the reflectances could vary within the ranges shown in FIG. 5. And if the reflectances of those storage layers are significantly different from each other, the S-curve signals obtained from the respective storage layers will have mutually different amplitudes as shown in portion (b) of FIG. 10, even in a situation where the optical disc is irradiated with a light beam with a constant read power of 1.1 mW. Then, in Step S93, to measure those amplitude values, the FE signal is converted by an A/D converter into a digital signal, which is then supplied to the S-curve signal detecting section 252 (which is implemented as a DSP), thereby detecting the peaks.

If the influence of the spherical aberration is non-negligible and if the amplitudes of the S-curve signals cannot be measured so accurately, then the amplitudes of the S-curve signals obtained from the respective storage layers are measured with the spherical aberration changed for one layer to another. As for a triple-layer disc, for example, the lens is moved with the spherical aberration set first on a depth of 100 μm, at which the L0 layer closest to the substrate is located, thereby measuring the amplitude of the S-curve signal obtained from the L0 layer. Next, the lens is further moved with the spherical aberration set on a depth of 75 μm, at which the L1 layer is located, thereby measuring the amplitude of the S-curve signal obtained from the L1 layer. And then the lens is further moved with the spherical aberration set on a depth of 57 μm, at which the L2 layer is located, thereby measuring the amplitude of the S-curve signal obtained from the L2 layer.

As for a quadruple-layer disc, on the other hand, the lens is moved with the spherical aberration set first on a depth of 100 μm, at which the L0 layer closest to the substrate is located, thereby measuring the amplitude of the S-curve signal obtained from the L0 layer. Next, the lens is further moved with the spherical aberration set on a depth of 84.5 μm, at which the L1 layer is located, thereby measuring the amplitude of the S-curve signal obtained from the L1 layer. Thereafter, the lens is further moved with the spherical aberration set on a depth of 65 μm, at which the L2 layer is located, thereby measuring the amplitude of the S-curve signal obtained from the L2 layer. And then the lens is further moved with the spherical aberration set on a depth of 53.5 μm, at which the L3 layer is located, thereby measuring the amplitude of the S-curve signal obtained from the L3 layer. That is to say, by moving the lens three and four times for a triple-layer disc and a quadruple-layer disc, respectively, with the spherical aberration changed adaptively to each of the three or four storage layers, the amplitudes of the S-curve signals obtained from the respective layers can be measured and their values can be recorded.

As a result, the amplitudes of the S-curve signals can be measured with spherical aberrations adapted to the respective storage layers. Consequently, with the influence of spherical aberration, which could manifest itself as a variation in depth between the respective storage layers, eliminated, the difference in amplitude between the S-curve signals, which is caused solely by a variation in reflectance, can be ironed out. Consequently, the read power table can be drawn up more accurately than in Step S94 to be described later.

After the amplitudes of the respective S-curve signals of the multiple storage layers have been measured, a read power table that makes those amplitude values equal to each other is drawn up in Step S94. In this preferred embodiment, if the amplitudes of the respective S-curve signals of the L3, L2, L1 and L0 layers are 1 v, 0.9 v, 1.1 v and 0.8 v, respectively, as shown in portion (b) of FIG. 10, then the S-curve signal amplitude and the read power of the L3 layer (which are 1 v and 1.1 mW, respectively) may be used as reference values to set read powers for the L2, L1 and L0 layers to be:

1.1×(1/0.9)=1.22 mW→1.2 mW,

1.1×(1/1.1)=1 mW and

1.1×(1/0.8)=1.375 mW→1.2 mW, respectively.

Then, the CPU 246 stores these read powers on the read power table 501b in the memory section 501. In addition, the memory section 501 also stores the maximum read powers, at or under which no damage would be done on the L0, L1, L2 and L3 layers shown in FIG. 5 by the read light beam, on the standard power table 501a. If the read powers that have been set while the amplitudes of the S-curve signals are measured as described above are greater than those maximum standard powers, then the read powers stored on the standard power table 501a may be defined to be the upper limits. In this manner, it is possible to prevent too intense a read light beam from destroying the data already stored. In the example illustrated in shown in portion (b) of FIG. 10, the best read powers for the L0 and L2 layers should actually be higher values but are limited to 1.2 mW in this example.

Finally, in Step S95, by reference to the read powers stored on the read power table 501b, a read power is set for a predetermined layer of the given optical disc. The read power that has been set in this processing step S95 will be used in focusing the light beam on a target storage layer, determining how many storage layers the given multilayer optical disc has, and shifting the focus from one storage layer to another as will be described later. If the read powers on the read power table 501b are used adaptively to the respective storage layers, then the S-curve signals obtained from the L1 and L3 layers will have an amplitude of 1 v but the S-curve signals obtained from the L0 and L2 layers will have an amplitude of 0.91 v as shown in portion (c) of FIG. 10.

As described above, the ability to avoid the damage that could be done by too intense a read light beam will vary according to a characteristic of the drive (i.e., the optical disc drive), more specifically, a variation in the operating wavelength of the semiconductor laser diode of an optical pickup built in that drive. In addition, from the standpoint of the optical disc to be irradiated with the light beam, the power received by the disc will change if there is a variation in the degree of efficiency of the optical system that the light beam should pass before being incident on the optical disc.

For that reason, it is extremely effective to draw up a standard read power table with standard values that are compliant with the industrial standard as shown in FIG. 5 and store that read power table in the standard power table section 501a that is implemented as an EEPROM in STEP 1. Specifically, for that purpose, the S-curve amplitudes of an FE signal may be measured during the manufacturing process of the drive using a standard multilayer optical disc, of which the reflectances of respective layers are already known to fall within the standard ranges as defined by that standard, and then a standard table of read powers that make the S-curve amplitudes constant on that optical disc may be drawn up. In that case, if several reference values are provided for individual drives and optical pickups, the difference between those optical pickups can be ironed out. As a result, when a read power table is drawn up in STEP 2 on a disc-by-disc basis as will be described later, more accurate values can be calculated.

Even in the same multilayer optical disc, the reflectance may vary from one layer to another according to the recording film material and reflective film material that are adopted by the manufacturer of the optical disc. For that reason, in STEP 2, when the optical disc drive is started by being loaded with a multilayer optical disc, the best read power table may be drawn up on a layer-by-layer basis for each individual disc based on the amplitudes of S-curve signals that vary according to the reflectance of each individual layer of the multilayer optical disc. In that case, if such a table is retained as a read power table 501b that is implemented as an EEPROM (or a DRAM), the read performance and the ability to avoid the damage that could be done by a read light beam can be both improved.

Optionally, the read power table 501b may have the same values as the standard power table 501a when the optical disc drive is shipped but may have its values updated afterward. Then, even if the read power table 501b could not be compiled because the optical disc loaded has turned out to either fail to comply with the standard or have poor quality, update of the read power table on the memory circuit 501b shown in FIG. 7 may be stopped. But if the read power table 501b has been compiled successfully, then the read power table on the memory circuit 501b may be updated. Also, if the read power table 501b is stored in a volatile memory such as a DRAM, then a read power table may be drawn up every time the optical disc drive is started.

### Formats for Standard Power Table and Read Power Table

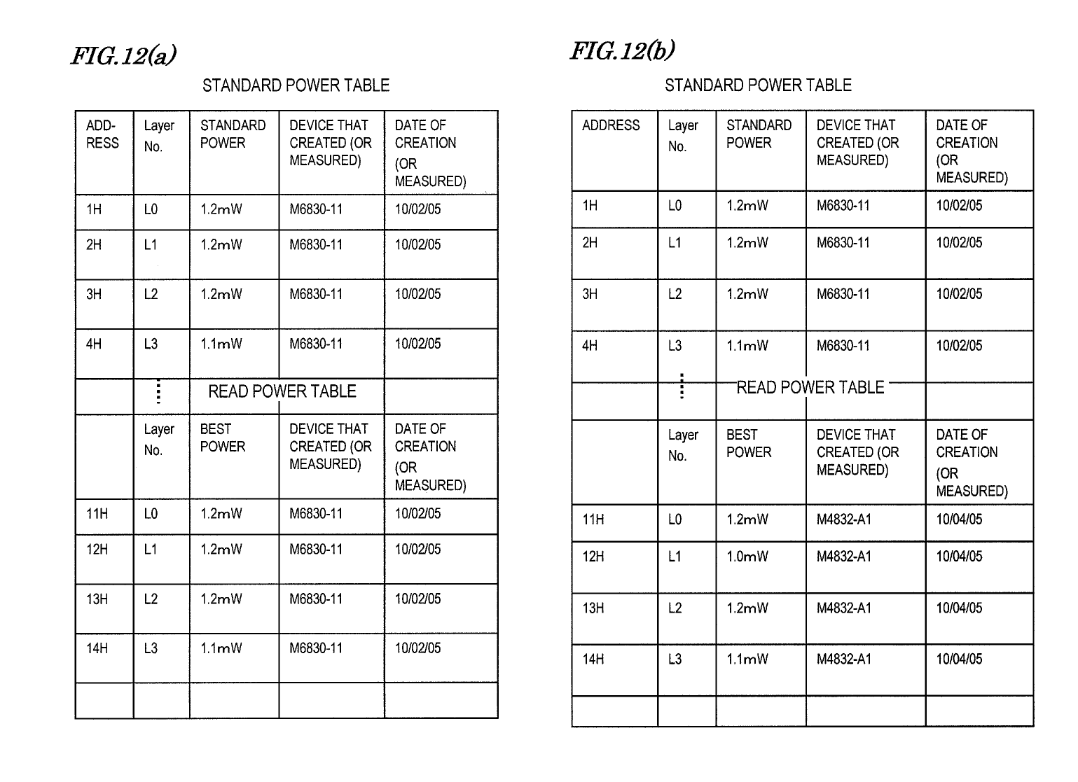

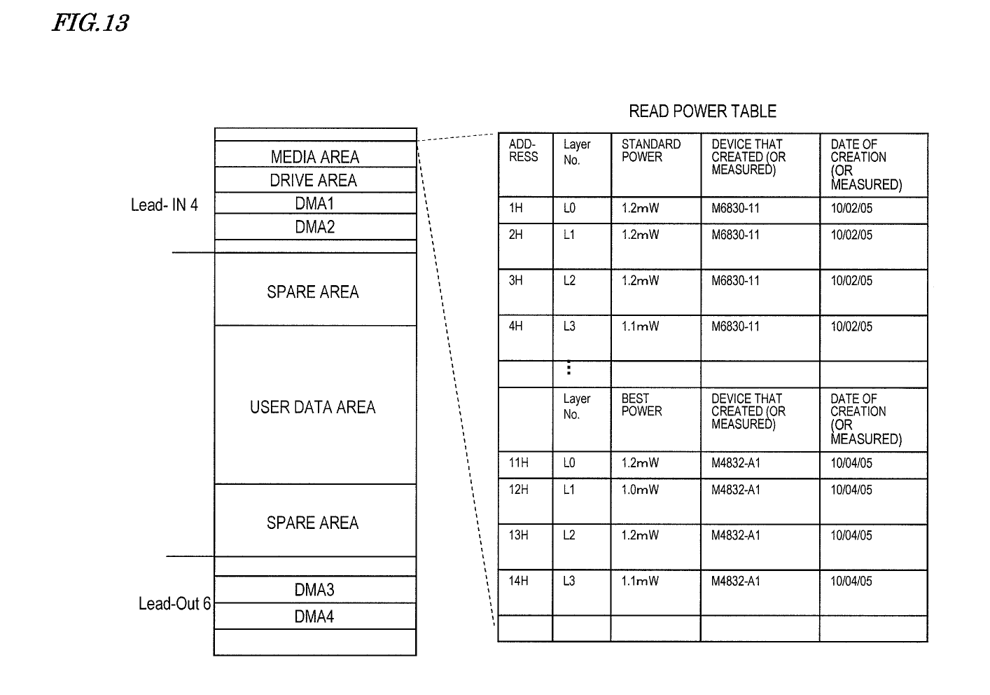

FIG. 12 shows exemplary formats for the standard power table and read power table of the quadruple layer BD-R described above.

The read power table may be written on an optical disc instead of being stored in a memory in the optical disc drive. In that case, a read power table storage area may be provided in the vicinity of a predetermined region of the information area for storing the write strategy on the innermost part of the optical disc and the read power table may be stored there as shown in FIG. 13. In that case, there is no need to store a lot of read power tables for a number of optical discs in a memory in the optical disc drive, and therefore, there is no concern about the available space and the number of times of rewrite of the EEPROM, either. Also, if the optical disc is designed so that any other optical disc drive makes reference to the read power table of each individual optical disc loaded, then compatibility with other inexpensive players can be increased without forcing them to draw up a read power table.

As shown in FIGS. 12 and 13, on a read power table, not just a read power but also the date of creation of that read power table and the serial number of the device that made it may be stored as well. In that case, a new read power table may be drawn up all over again when a predetermined amount of time passes since that date of creation. Then, it is possible to cope with any deterioration with time of the optical pickup or semiconductor laser diode or that of the optical disc. Furthermore, if it has turned out, by the serial numbers of the drives, that the optical disc drive that made the table and another optical disc drive are of the same kind of devices that were manufactured in the same lot, then the read power table stored in the disc may be referred to as it is. On the other hand, if those two drives have turned out to be mutually different kinds of devices that were manufactured in two different lots, then another read power table may be either drawn up all over again (i.e., update the read power table shown in FIG. 12(a) into the one shown in FIG. 12(b)) or added to the old one (i.e., make the read power table shown in FIG. 12(b) in addition to the one shown in FIG. 12(a)). In this manner, it is possible to cope flexibly with any variation between devices of multiple generations or between the manufacturing lots.

In the preferred embodiment described above, the best powers of the read power table are supposed to be calculated using the read power for the shallowest L3 or L2 layer as a reference power. However, the best powers may also be calculated using the read power for a layer with the lowest reflectance (i.e., having the smallest S-curve amplitude) as a reference power. In that case, the read powers for the other layers are adjusted by decreasing them so that the respective storage layers of a multilayer optical disc have their S-curve signal amplitudes (i.e., their reflected light intensities) equalized with each other. As a result, the optical disc drive can be started even more smoothly.

In every Blu-ray Disc, its reference layer is always the L0 layer that is located closest to the substrate, no matter how many storage layers the disc has (i.e., in all of single-, double-, triple- and quadruple-layer discs). In these optical discs, their reference layer is also located at the same depth and has the same spherical aberration value, too. That is why in the manufacturing process of the optical disc drive, calibration is often made at a lens position where the spherical aberration correction lens 228 shown in FIG. 8 causes a spherical aberration of 100 μm. Therefore, a read power table may also be drawn up for a multilayer optical disc so that the spherical aberration becomes minimum at a depth of 0.1 mm and that the read power for the L0 layer is used as a reference for determining read powers for the other layers. Then, it is possible to avoid an unwanted situation where the S-curve signal amplitude varies with the spherical aberration. As a result, the accuracy of the table values can be further increased.

As described above, according to the read power setting method of this preferred embodiment, the best read powers for the three, four or more storage layers of a multilayer optical disc can be set more easily and more quickly.

### Multilayer Disc Type Recognition and Focus Finding Methods

Hereinafter, it will be described how to recognize the type of a given multilayer optical disc (or how to determine the number of its storage layers), and how to perform a focus finding operation while starting the optical disc drive, by using the read power table that has been drawn up by the read power setting method described above.

### Multilayer Disc Type Recognition Method

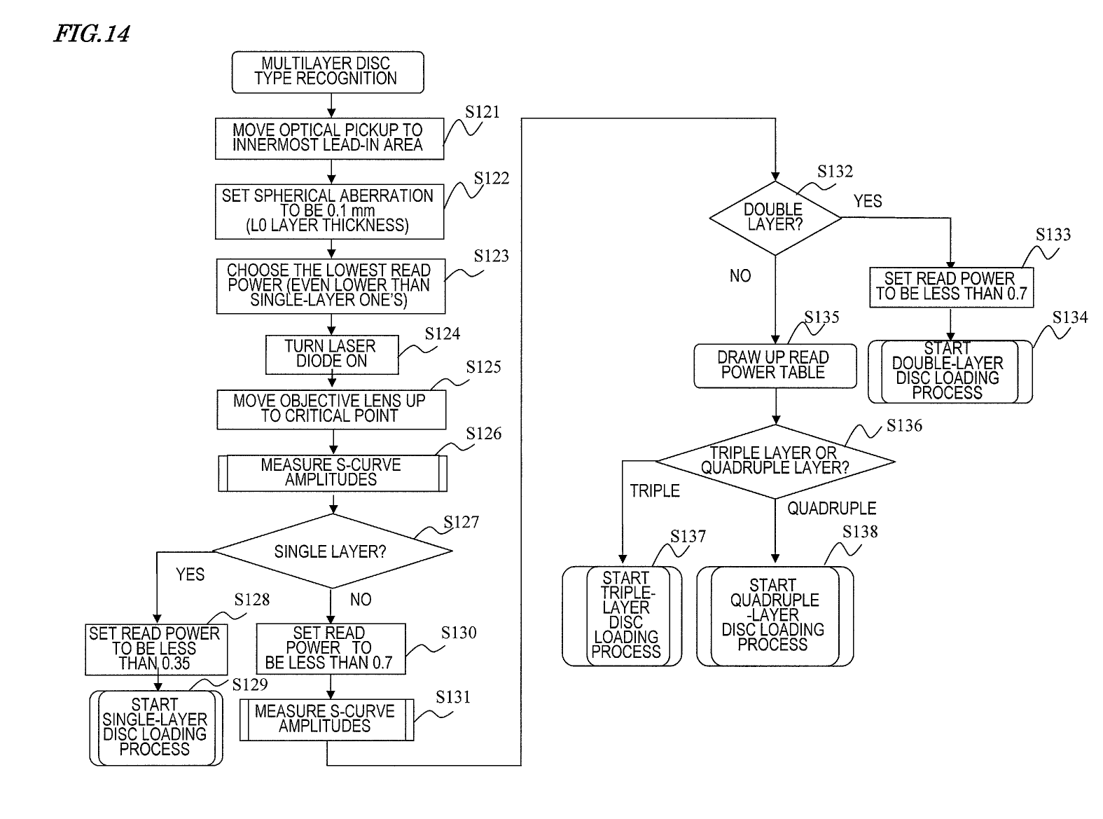

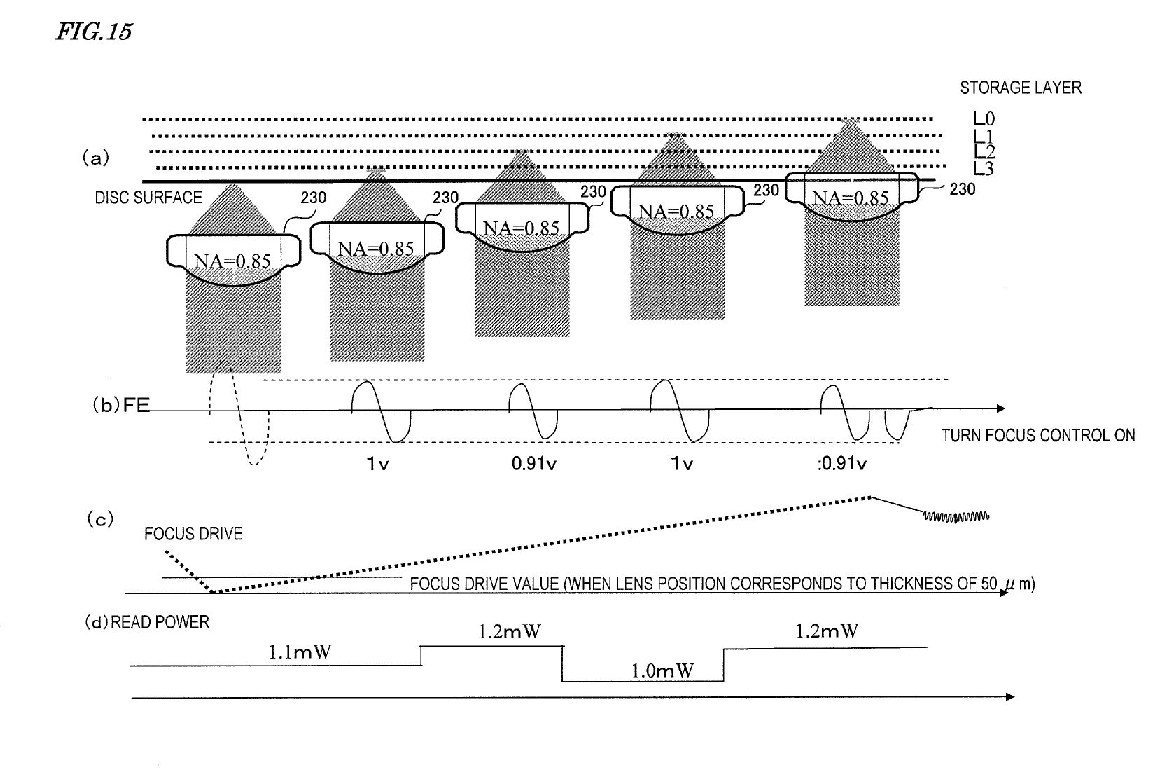

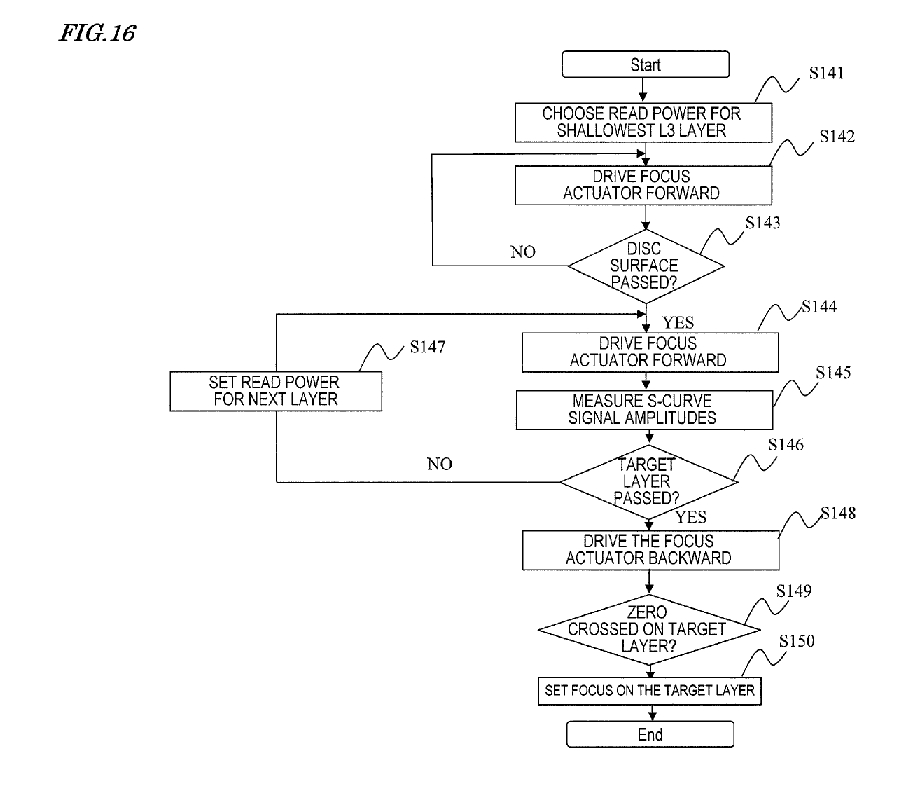

FIG. 14 is a flowchart showing the procedure of determining how many storage layers a given multilayer optical disc has according to the first preferred embodiment of the present invention. In the following example, the multilayer optical disc is supposed to have at most four storage layers. However, this is only an example of the present invention.

First of all, in Step S121, when the optical disc drive is loaded with a BD disc, the optical pickup is moved to a predetermined location in the vicinity of the innermost part of the BD disc (e.g., to the innermost lead-in area). At that location, there are few scratches, if any, and there must be the disc loaded, no matter how small its diameter is. In a preferred embodiment of the present invention, the optical disc is not rotating but in rest position.

Next, in Step S122, the spherical aberration is set adaptively to the cover layer thickness (of 0.1 mm) of a single-layer BD. That is to say, the spherical aberration corrector 228 shown in FIG. 7 is adjusted so that the spherical aberration is minimized at the L0 layer of a single-layer BD. Subsequently, in Step S123, the read power is set to be such a value, at which the read light beam would do no damage at all even on a type of an optical disc to be irradiated with a light beam with lower read power than any other one of the multiple types of optical discs compatible with the drive. Specifically, in this preferred embodiment, the read power is set to be 0.3 mW, which is lower than 0.35 mW that is a read power defined for a single-layer BD.

Thereafter, in Step S124, the semiconductor laser diode (LD) in the optical pickup is turned ON. Next, while the objective lens is moved to a critical point in Step S125, S-curve signals that appear on the FE signal have their amplitudes measured and are counted in Step S126. Then, in Step S127, it is determined, by the count of those S-curve signals, whether or not the optical disc loaded is a single-layer optical disc. Since the read power has been adjusted adaptively to a single-layer disc, this decision can be made just as intended.

If the optical disc loaded has turned out to be a single-layer BD in Step S127, then the power is adjusted in the next processing step S128 to a level that is high enough to ensure a read signal of quality. After that, in Step S129, the disc loading process is carried out in the predetermined procedure that is defined for a single-layer BD.

On the other hand, if the optical disc loaded has turned out to be a non-single-layer optical disc in Step S127, then the read power is set in Step S130 to be lower than 0.7 mW (e.g., 0.6 mW), which is a read power defined for a double-layer disc. Next, by moving the objective lens to a critical point, S-curve signals that appear on the FE signal have their amplitudes measured and are counted in Step S131. Then, in Step S132, it is determined, by the count of those S-curve signals, whether the optical disc loaded is a double-layer disc or a multilayer disc with three or more storage layers. Since the read power has been set adaptively to a double-layer disc, this decision can be made just as intended as in deciding whether the disc loaded is a single-layer one or not.

If the optical disc loaded has turned out to be a double-layer BD in Step S132, then the power is adjusted in the next processing step S133 to a level that is high enough to ensure a read signal of quality. After that, in Step S134, the disc loading process is carried out in the predetermined procedure that is defined for a double-layer BD.

On the other hand, if the optical disc loaded has turned out in Step S132 to be not a double-layer BD but a multilayer disc (i.e., a triple- or quadruple-layer BD), then the process advances to Step S135. In that case, following the procedure shown in FIG. 11, the S-curve signals have their amplitudes measured and counted using a light beam with the lowest read power (of 1.1 mW) of all read power values that have been defined for respective storage layers of a multilayer optical disc. In this manner, a read power table 501b is drawn up for each storage layer. Since the S-curve signals have their amplitudes measured and counted in this case, it can also be determined in Step S136 whether the multilayer disc loaded is a triple-layer disc or a quadruple-layer one.

When the read power table 501b is drawn up, the read power is set equal to the lowest one of all read powers for the three or four storage layers of the disc. After that, following a predetermined procedure for a triple-layer or quadruple-layer BD, the disc loading process is carried out (in Step S137 or S138).

### Focus Finding Method

Hereinafter, it will be described exactly how to set a read power for the target storage layer, on which the light beam needs to be focused, using the read power table. In the following example, the optical disc loaded is supposed to be a quadruple-layer disc. However, substantially the same procedure is applicable to a triple-layer disc, too, although the number of storage layers included is smaller by one.

According to the read power table shown in FIG. 12(b), the best powers for the L0, L1, L2 and L3 layers are 1.2 mW, 1.0 mW, 1.2 mW and 1.1 mW, respectively.

FIG. 15 shows how the waveforms of respective signals applied change while the light beam is focused on respective storage layers of a quadruple-layer disc. Specifically, portion (a) of FIG. 15 shows the waveforms of S-curve signals obtained from the respective storage layers. Portion (b) of FIG. 15 shows how the waveform of a focus drive signal changes while the light beam is being focused on. And portion (c) of FIG. 15 shows how the read power is changed whenever the light beam passes through any of those storage layers.

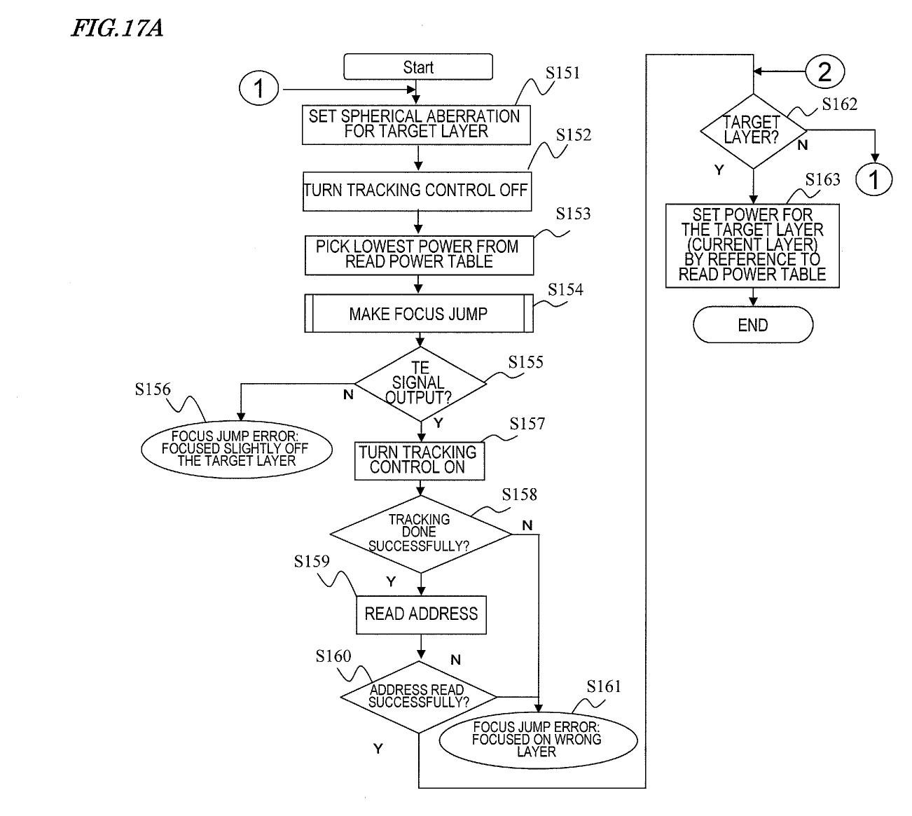

FIG. 16 is a flowchart showing the procedure of performing a focus finding operation on a quadruple-layer disc according to this first preferred embodiment of the present invention. To begin with, it will be described how to focus the light beam on the L0 layer, which is the deepest storage layer that is located closest to the substrate.

First of all, in Step S141, with the objective lens kept way off the disc surface, the CPU (that functions as a control section) 246 gets the read power controlled by the laser driver 502 to the best power of 1.1 mW for the L3 layer that is stored on the read power table 501b. Next, the CPU 246 instructs the spherical aberration control section 242 to adjust the spherical aberration to a depth of 100 μm, at which the deepest L0 layer is located. Then, in Step S142, the CPU 246 makes the focus actuator 232 inch the objective lens toward the optical disc. In this case, the value that has been extracted from the read power table 501b has been optimized with respect to the reflectance of the disc. That is why the amplitude of an S-curve signal obtained from any of the storage layers is rather close to approximately 1 V that is a predetermined amplitude, and therefore, the S-curve signal can be detected just as intended from any of the multiple storage layers.

As the objective lens is brought closer to the optical disc by driving the focus actuator 232, a surface S-curve signal soon appears in Step S143. The objective lens is moved even closer to the optical disc by further driving the focus actuator 232 in the next processing step S144. And if the surface S-curve signal has already been detected or if the focus of the light beam has already reached a predetermined depth (e.g., 50 μm that is the cover layer thickness of the shallowest layer) or even beyond it, the next S-curve signal detected will represent the L3 layer.

When a local maximum or local minimum value of that S-curve signal representing the L3 layer is detected in Steps S145 and S146, the CPU 246 gets the read power changed by the laser driver 502 to 1.2 mW, which is a read power for the L2 layer that is stored in the read power table 501b, in the next processing step S147. As the objective lens is brought even closer to the optical disc, an S-curve signal representing the L2 layer soon appears. And when a local maximum or local minimum value of that S-curve signal representing the L2 layer is detected in Steps S145 and S146, the CPU 246 gets the read power changed by the laser driver 502 to 1.0 mW, which is a read power for the L1 layer that is stored in the read power table 501b, in the next processing step S147. Thereafter, as the objective lens is brought even closer to the optical disc, an S-curve signal representing the L1 layer soon appears.

When a local maximum or local minimum value of that S-curve signal representing the L1 layer is detected in Steps S145 and S146, the CPU 246 gets the read power changed by the laser driver 502 to 1.2 mW, which is a read power for the L0 layer that is stored in the read power table 501b, in the next processing step S147. As the objective lens is brought even closer to the optical disc, an S-curve signal representing the L0 layer soon appears.

The local maximum or minimum value of the S-curve signal representing the L0 layer is detected in Step S145. Next, in Step S146, the CPU 146 determines whether or not the focus of the light beam has already passed the target L0 layer. If the answer is YES, the CPU 246 drives the focus actuator in the opposite direction in Step S148, thereby moving the objective lens 230 slowly away from the optical disc. Then, the S-curve signal representing the L0 layer soon appears again, when its local maximum or local minimum value is detected. After that, the focus control is turned ON around the zero-cross point (Z point) in Step S149, thereby focusing the light beam on that target storage layer eventually in Step S150. Since the read power at this point in time is 1.2 mW that is the best read power for the L0 layer, various problems that could be caused by too intense a read light beam or servo instability can be avoided.

As described above, according to the focus finding method of this preferred embodiment, after having detected an S-curve signal (and its local maximum or minimum value), the CPU (control section) 246 changes the read power into the one defined for the next storage layer by reference to the read power table 506b. That is why the read power can be changed immediately into the best one for each of the three, four or more storage layers included in a given multilayer optical disc.

Next, it will be described with reference to FIG. 16 what if the light beam needs to be focused on the L3 layer that is the shallowest layer that is located closest to the disc surface.

First of all, in Step S141, with the objective lens kept way off the disc surface, the read power is controlled to the best power of 1.1 mW for the L3 layer by reference to the read power table 501b and the spherical aberration is adjusted to a depth of 53.5 μm, which is the cover layer thickness of the shallowest L3 layer. Then, in Step S142, the objective lens is driven by the focus actuator 232 to come gradually closer to the optical disc. In this case, the read power that has been set by reference to the read power table 501b has been optimized with respect to the reflectance of the L3 layer.

As the objective lens is brought closer to the optical disc, a surface S-curve signal soon appears in Step S143. And if the surface S-curve signal has already been detected or if the focus of the light beam has already reached a predetermined depth (e.g., 50 μm that is the cover layer thickness of the shallowest layer) or even beyond it in Step S144, the next S-curve signal detected will represent the L3 layer. Thus, if it has been determined in Step S146 that the focus of the light beam has already passed the target L3 layer after the local maximum or local minimum value representing the shallowest L3 layer has been detected in Step S145, the objective lens is moved slowly away from the optical disc in Step S148. Then, the S-curve signal representing the L3 layer soon appears again, when the focus control is turned ON around the zero-cross point (Z point) in Step S149, thereby focusing the light beam on that target storage layer eventually in Step S150. Since the read power at this point in time has been optimized for the L3 layer, various problems that could be caused by too intense a read light beam or servo instability can be avoided.

In the examples described above, the light beam is supposed to be focused on either the deepest layer or the shallowest layer. However, the focus finding procedure described above is naturally applicable to any other storage layer as well.

In any case, after the light beam has been focused on the target storage layer, the tracking control is turned ON. After that, data about spherical aberrations and servo gains are collected for learning purposes. Subsequently, the address of the track on which the light beam spot is currently located is read, and then the light beam spot is moved toward the innermost information area to retrieve predetermined disc data from it. Thereafter, to collect data for learning or obtain information from another layer in accordance with the loading process sequence, the focus of the light beam is shifted to the next layer by performing a focus jump operation.

As described above, by using the read power table 501b, the risk of suffering the damage that could be caused by a read light beam can be reduced just as intended and the focus finding and loading processes can get done with good stability.

### Focus Jump Method

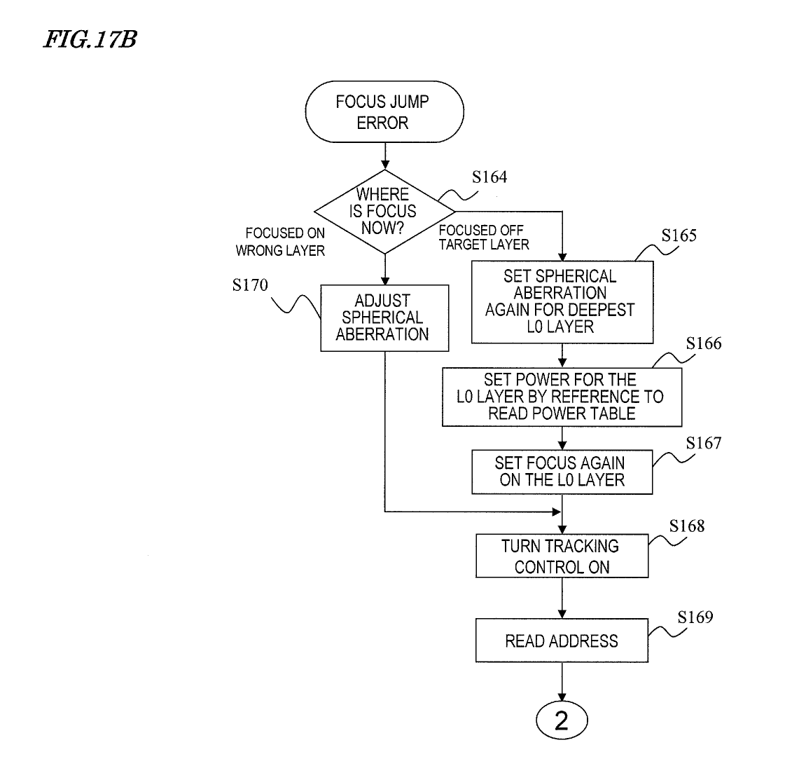

Hereinafter, it will be described with reference to FIGS. 17A and 17B how to perform a focus jump operation in order to shift the focus of the light beam from one storage layer of a multilayer optical disc to another with the read power changed. FIGS. 17A and 17B are flowcharts showing how to perform the focus jump operation according to this first preferred embodiment of the present invention.

Generally speaking, the spherical aberration cannot be changed as quickly as the read power. For that reason, according to this preferred embodiment, the spherical aberration is set adaptively to the target storage layer and then the read power is determined by reference to the read power table so as to prevent the read light beam from doing damage on the target layer. After that, the focus jump operation is carried out immediately. And when it is confirmed that the light beam spot has reached the target layer, the read power is changed into the best value for that layer.

First, in Step S151, on receiving a layer change instruction from the host 140, the CPU (that functions as a control section) 246 makes the spherical aberration control section 242 set a spherical aberration corresponding to the depth of the target storage layer. For example, if the light beam spot needs to be moved from the L0 layer of a triple-layer disc to the L2 layer thereof, then the spherical aberration corresponding to a depth of 0.1 mm is changed into the one corresponding to a depth of 0.057 mm. In the next processing step S152, the CPU 246 once turns the tracking control OFF.

Next, in Step S153, the CPU 246 gets the lowest one of the powers that are stored on the read power table 501b in the memory circuit 501 set by the laser driver 502. In this case, the lowest power is used to protect the data from the damage that could be done by too intense a read light beam in a situation where some external impact or disc flutter has caused the light beam spot to either skip the target storage layer to reach the next layer or go back to the previous storage layer by mistake.

Subsequently, in Step S154, the CPU 246 applies either an acceleration pulse or deceleration pulse to the focus control section 240, thereby performing a focus jump operation. As for the focus jump operation, various driving schemes and methods have already been proposed, and the description thereof will be omitted herein.

If a TE signal is being output when the focus jump operation is done (i.e., when the deceleration pulse finishes being applied), then it can be seen that the light beam has been focused on the target storage layer successfully. On the other hand, if it has been determined in Step S155 that no TE signal is being output, then it can be seen in Step S156 that a focus jump error has occurred because the objective lens has collided against either the lowest point of the disc or a stopper and the focus control has failed.

If the focus jump operation has been confirmed to be a success by detecting the output of a TE signal, then the tracking control is promptly turned ON in the next processing step S157. And if in Step S158, the output of the TE signal is sensed to have converged and it has been confirmed with a TROK flag that the light beam has been focused on the right track on the target storage layer successfully, then the address modulated by a wobbled track is read in Step S159. However, if no address can be read or if the tracking control cannot get done in Step S158, then a focus jump error is indicated in Step S161 because the light beam spot should be located on a wrong layer other than the target one in that case.

And if the address can be read successfully in Step S160, then it is determined by that value in Step S162 whether or not the target storage layer has been reached. If the answer is YES, the CPU 246 gets the best power for that storage layer, which is stored on the read power table 506b, set by the laser driver 502 to end the focus jump operation. On the other hand, if the current layer has turned out to be a non-target layer in Step S162, then the same series of focus jump processing steps are carried out all over again from the beginning.

If the focus jump error has been indicated, then any of the following two different series of processing steps is pursued depending on where the error has occurred. On the one hand, if it has been determined in Step S164 that the light beam has just gone out of focus with respect to the target layer and its focus is still around the target layer, the CPU 246 once again makes the spherical aberration control section 242 set a spherical aberration corresponding to the depth of the L0 layer (or any other target layer) in Step S165. After that, the CPU 246 performs a series of processing steps for setting the lowest power in Step S166 by reference to the read power table 501b on the memory circuit 501, getting the light beam focused on the L0 layer (or any other target layer) in Step S167, turning the tracking control ON in Step S168, and then reading the address in Step S169.

On the other hand, if it has been determined in Step S164 that the light beam has been focused on a wrong layer by mistake, then the spherical aberration is once adjusted to that layer in Step S170. In this case, the spherical aberration may be adjusted so as to maximize the amplitude of the TE signal (or increase the amplitude of the TE signal to a predetermined value or more). This is done to read the address signal, as well as the TE signal, based on the diffracted light because the address signal is also included there as a component that has been modulated by the wobbled track. Once the spherical aberration has been adjusted, the tracking control is turned ON in Step S168 and the address is read in Step S169 in series as in the situation where the light beam has just gone out of focus. As long as the address can be read successfully, it can be determined on which layer the light beam spot is currently located, and therefore, the focus jump operation has only to be retried.

In the example described above, the lowest power is supposed to be chosen by reference to the read power table 501b to protect the data from the damage that could be done by too intense a read light beam in a situation where some external impact or disc flutter has caused the light beam spot to either skip the target storage layer to reach the next layer or go back to the previous storage layer by mistake.

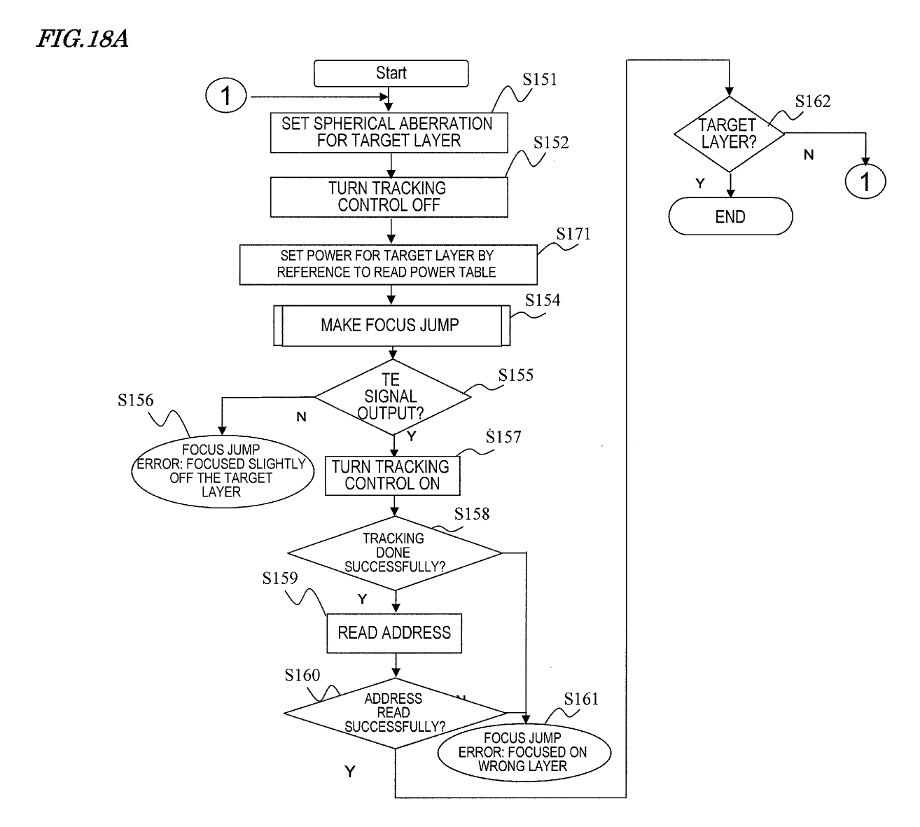

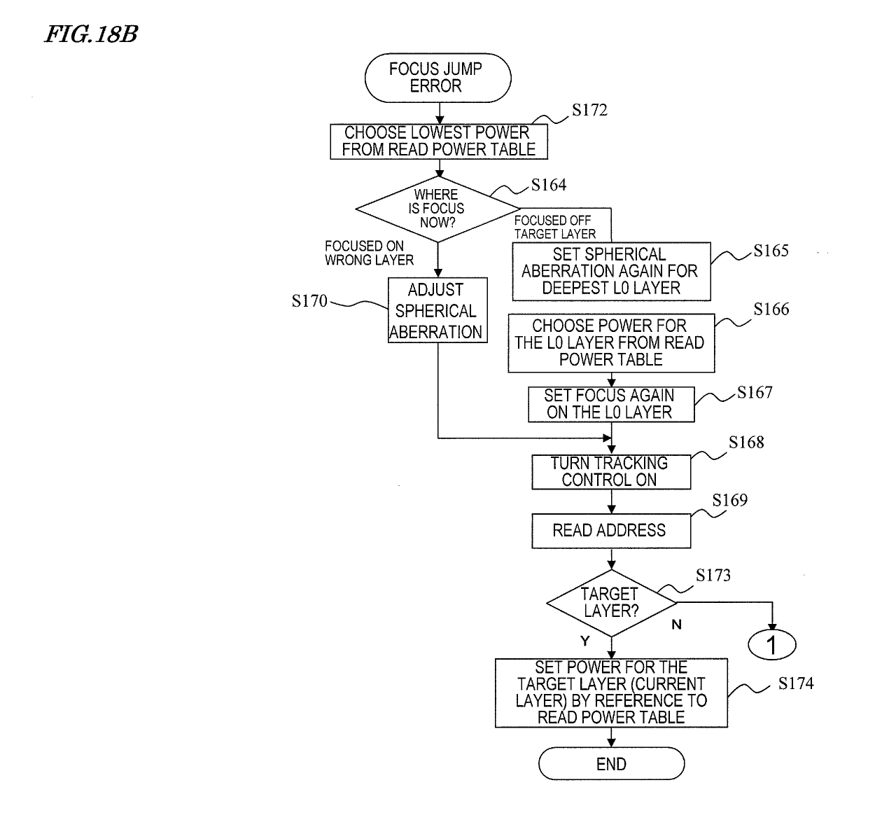

Hereinafter, a different focus jump method from what has just been described with reference to FIGS. 17A and 17B will be described with reference to FIGS. 18A and 18B, which are flowcharts showing the procedure of that alternative focus jump method according to the present invention.

The focus jump method shown in FIGS. 18A and 18B has mostly the same flow as the one shown in FIGS. 17A and 17B except the following differences:
(1) Although the lowest read power is set in Step S153 by reference to the read power table 501b, a read power for the target layer is set in Step S171 according to this alternative method by reference to the read power table 501b;
(2) When the light beam is focused on the target layer successfully as a result of the focus jump operation, the read power for the target layer is set in Step S163 by reference to the read power table 501b. On the other hand, this alternative focus jump process ends without setting the read power once it has been confirmed in Step S162 that the target layer is reached;
(3) This alternative focus jump process further includes an additional processing step S172 for setting the lowest read power by reference to the read power table 501b before Step S164 is performed;
(4) The address reading processing step S169 is followed according to this alternative method by another additional processing step S173 for determining whether or not the target layer has been reached; and
(5) And then the additional processing step S173 is followed by yet another additional processing step S174 for setting the read power for the target layer by reference to the read power table 501b.

In summary, according to this alternative method, right after the spherical aberration and read power (chosen from the read power table 501b) have been set for the target layer for a start in Steps S151, S152 and S171, a focus jump operation is carried out in Step S154. And when it is confirmed in Step S160 and S162 that the target layer has been reached by performing a tracking control and reading the address in Step S157, S158 and S159, this focus jump procedure ends.

On the other hand, if it has been determined in Step S161 that the focus jump has failed and the light beam has been focused on a wrong layer by mistake, then the read power is changed into the lowest one in Step S172 by reference to the read power table 501b. Next, the spherical aberration is once adjusted in Step S170 with respect to that wrong layer or the tracking control is turned ON in Step S168 and the address is read in Step S169. Thereafter, it is determined, by either the spherical aberration adjusted or the address read, on which storage layer the light beam spot is currently located. And then the read power is set again in Steps S173 and S174 with respect to that layer by reference to the read power table 501b. According to this method, the normal process can get done more quickly with even more stability.

As described above, by using the read power table, the risk of suffering the damage that could be caused by a read light beam can be reduced just as intended and the focus jump operation can get done with good stability.

In the preferred embodiments of the present invention described above, the optical disc drive is supposed to perform a disc type recognition operation to determine whether or not the optical disc loaded is a multilayer optical disc with three or more storage layers. However, such a disc type recognition operation is not an essential one for the present invention. Alternatively, the user may enter, by him- or herself, information indicating whether or not the optical disc that he or she is going to load into the optical disc drive is a multilayer optical disc with three or more storage layers. By reference such information entered, the optical disc drive can decide whether or not the optical disc loaded is a multilayer optical disc with three or more storage layers.

An optical disc drive according to the present invention sets the best read power for each of multiple storage layers in a multilayer optical disc loaded, thus getting the disc loading process done smoothly. That is why the present invention is applicable for use in players, recorders, personal computers (PCs) and other devices that read and/or write data from/to a multilayer optical disc loaded.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This application is based on Japanese Patent Applications No. 2010-034477 filed Feb. 19, 2010 and No. 2011-023873 filed Feb. 7, 2011, the entire contents of which are hereby incorporated by reference.

What is claimed is:

1. An optical disc drive for reading data from an optical disc loaded, the drive comprising:
a light source for emitting a light beam;
an objective lens for converging the light beam; and
a photodetector for detecting the light beam that has been reflected from the optical disc,
wherein if the disc loaded is a multilayer optical disc with three or more storage layers, the optical disc drive sets a read power for at least one of the storage layers to be lower than read power(s) for the other storage layers.

2. The optical disc drive of claim 1, wherein if the disc loaded is a multilayer optical disc with three or more storage layers, the ratio of read powers for the respective storage layers is fixed for the same type of the disc.

3. The optical disc drive of claim 1, wherein if the disc loaded is a multilayer optical disc with three or more storage layers, the ratio of read powers for the respective storage layers is changed adaptively to the multilayer optical disc.

4. The optical disc drive of claim 3, wherein the ratio of the read powers for the respective storage layers is changed according to the ratio of the amplitudes of respective S-curves of a focus error signal that are obtained from the respective storage layers of the multilayer optical disc.

5. The optical disc drive of claim 4, wherein the ratio of the read powers for the respective storage layers is changed so that the respective S-curves of the focus error signal obtained from the respective storage layers of the multilayer optical disc have amplitudes that fall within a preset range.

6. The optical disc drive of claim 5, wherein the read power for that target storage layer will be changed according to the ratio of the read powers for the respective storage layers when the light beam is focused on the target layer.

7. The optical disc drive of claim 5, wherein when the focus is shifted from one of the storage layers to another by performing a focus jump operation, the read power for the latter storage layer will be changed according to the ratio of the read powers for the respective storage layers.

8. The optical disc drive of claim 1, wherein when loaded with an optical disc, the drive performs an operation for detecting the number of storage layers that the optical disc has.

9. The optical disc drive of claim 8, wherein when loaded with an optical disc, the drive performs an operation for detecting the number of storage layers that the optical disc has and then determining, by the number of the storage layers detected, whether or not that disc is a multilayer optical disc with three or more storage layers.

10. The optical disc drive of claim 8, wherein in detecting the number of storage layers that the optical disc loaded has, the drive irradiates the optical disc with a light beam, of which the power is higher than the maximum one of read powers for the respective storage layers, and changes the focus position of the light beam simultaneously, thereby counting the number of times S-curves have been detected from a focus error signal.

11. The optical disc drive of claim 10, wherein the ratio of the read powers for the respective storage layers is determined by the amplitudes of respective S-curves of the focus error signal that are obtained from the respective storage layers of the multilayer optical disc when the number of storage layers that the optical disc loaded has is detected.

12. A method for reading data from an optical disc loaded, the method comprising the steps of:
(A) determining whether or not the disc loaded is a multilayer optical disc with three or more storage layers; and
if the answer is YES,
(B) setting a read power for at least one of the storage layers to be lower than read power(s) for the other storage layers.

13. The method of claim 12, wherein the step (B) includes fixing the ratio of read powers for the three or more storage layers for the same type of the multilayer optical disc.

14. The method of claim 12, wherein the step (B) includes changing the ratio of read powers for the three or more storage layers adaptively to the multilayer optical disc.

15. The method of claim 14, wherein the step (B) includes changing the ratio of the read powers for the respective storage layers according to the ratio of the amplitudes of respective S-curves of a focus error signal that are obtained from the respective storage layers of the multilayer optical disc.

16. The method of claim 15, wherein the step (B) includes changing the ratio of the read powers for the respective storage layers so that the respective S-curves of the focus error signal obtained from the respective storage layers of the multilayer optical disc have amplitudes that fall within a preset range.

17. The method of claim 16, further comprising the step of (C) focusing the light beam on a target one of the storage layers,
wherein the step (C) includes changing the read power for that target storage layer according to the ratio of the read powers for the respective storage layers when the light beam is focused on the target layer.

18. The method of claim 16, further comprising the step of (D) shifting the focus of the light beam from one of the storage layers to another by performing a focus jump operation,
wherein the step (D) includes changing the read power for the latter storage layer according to the ratio of the read powers for the respective storage layers when the focus is shifted to that layer.
